(19) United States
(12) Patent Application Publication
(10) Pub. No.: US 2009/0158299 A1
(43) Pub. Date: Jun. 18, 2009

(54) System for and method of uniform synchronization between multiple kernels running on single computer systems with multiple CPUs installed

(76) Inventor: Ernst B. Carter, San Francisco, CA (US)

Correspondence Address: HAVERSTOCK & OWENS LLP, 162 N WOLFE ROAD, SUNNYVALE, CA, 94086, US

(21) Appl. No.: 12/290,535

(22) Filed: Oct. 30, 2008

Related U.S. Application Data
(60) Provisional application No. 61/001,393, filed on Oct. 31, 2007.

(51) Int. Cl. G06F 3/00; G06F 9/46; G06F 13/00

(52) U.S. Cl. 719/319; 718/100

(57) ABSTRACT

The present invention allocates resources in a multi-operating system computing system, thereby avoiding bottlenecks and other degradations that result from competition for limited resources. In one embodiment, a computer system includes resources and multiple processors executing multiple operating systems that provide access to the resources. The resources include printers, disk controllers, memory, network controllers, and other often-accessed resources. Each operating system contains a kernel scheduler. Together, the multiple kernel schedulers are configured to coordinate allocating the resources to processes executing on the computer system.

### RELATED APPLICATIONS

This application claims priority under 35 U.S.C. §119(e) of the co-pending U.S. provisional patent application Ser. No. 61/001,393, filed on Oct. 31, 2007, and titled “System and Method for Uniform Synchronization Between Multiple Kernels Running on Single Computer Systems with Multiple CPUs Installed,” which is hereby incorporated by reference in its entirety.

### FIELD OF THE INVENTION

This invention relates to computing systems. More specifically, this invention relates to allocating resources to processes on computing systems that execute multiple operating systems.

### BACKGROUND OF THE INVENTION

Resources used by computers vary and are distributed throughout computing environments, but they are needed before a job can be completed. When multiple processes are executing simultaneously, as is usually the case, bottlenecks are created at the resources. These bottlenecks can occur at I/O bus controllers, in memory controllers during swap sequences, or when a program is preempted due to its request for a memory load when a memory dump has been initiated.

The occurrence of bottlenecks and thus process starvation increases even on systems that execute multiple operating systems. The extra processes that execute on these systems increase the probability that processes will simultaneously request the same resource or that processes that are waiting on each other to release resources will starve.

### SUMMARY OF THE INVENTION

In a first aspect of the present invention, a computer system includes multiple resources and a memory containing multiple operating systems. Each operating system contains a kernel scheduler configured to coordinate allocating the resources to processes executing on the computer system. In one embodiment, the computer system also includes multiple central processing units each executing a different one of the multiple operating systems. The multiple resources are any two or more of a keyboard controller, a video controller, an audio controller, a network controller, a disk controller, a universal serial bus controller, and a printer.

Preferably, the multiple kernel schedulers are configured to share resource-related information using a communications protocol. In one embodiment, the communications protocol is configured to access a shared memory. Alternatively, the communications protocol comprises interprocess communication or protocol stacks, Transmission Control Protocol/ Internet Protocol (TCP/IP). Alternatively, the communications protocol includes accessing semaphores, pipes, signals, message queues, pointers to data, and file descriptors. In one embodiment, the processes include at least three processes communicating with each other.

In one embodiment, each of the multiple kernel schedulers comprises a relationship manager for coordinating allocating the resources. Each of the multiple relationship managers comprises a resource manager configured to determine resource information about one or more of the multiple resources. The resource information is an estimated time until a resource becomes available.

In a second aspect of the present invention, a computer system includes a memory containing a kernel scheduler and multiple operating system kernels configured to access multiple resources. The kernel scheduler is configured to assign a process requesting a resource from the multiple resources to a corresponding one of the multiple operating system kernels. The system also includes multiple processors each executing a corresponding one of the multiple operating systems.

In one embodiment, the kernel scheduler schedules processes on the multiple operating system kernels based on loads on the multiple processors.

In one embodiment, the computer system also includes a process table that matches a request for a resource with one or more of the multiple operating system kernels. In another embodiment, the computer system also includes communications channels between pairs of the multiple operating system kernels. The multiple operating system kernels are configured to exchange information about processor load, resource availability, and estimated times for resources to become available.

In a third aspect of the present invention, a kernel scheduling system includes multiple processors and an assignment module. Each of the multiple processors executes an operating system kernel configured to access one or more resources. The assignment module is programmed to match a process requesting a resource to one of the multiple operating system kernels and to dispatch the process to the matched operating system kernel. Preferably, each of the multiple processors is controlled by a corresponding processor scheduler.

In a fourth aspect of the present invention, a method of assigning a resource to an operating system kernel includes selecting an operating system kernel from among multiple operating system kernels based on its ability to access the resource and assigning the process to the selected operating system kernel. The multiple operating system kernels all execute within a single memory.

In a fifth aspect of the present invention, a method of sharing process execution among first and second operating systems on a memory of a single computer system includes executing a process within the memory under control of the first operating system and transferring control of the process to a second operating system within the memory. In this way, the process is executed within the memory under the control of the second operating system. Executing the process under control of the first and second operating systems both access a single resource. In one embodiment, the method also includes exchanging process information between the first and second operating systems using one of shared memory, inter-process communication, and semaphores.

### BRIEF DESCRIPTION OF THE DRAWINGS

FIG. 1 is an abstract schematic of a kernel operating scheduler (KOS) in accordance with one embodiment of the present invention.

FIG. 2 is an abstract schematic of a kernel operating scheduler (KOS) in accordance with another embodiment of the present invention.

FIG. 3 shows a state diagram for kernel process scheduling in accordance with one embodiment of the present invention.

FIG. 4 shows a system with additional features in the KOS design in accordance with one embodiment of the present invention.

FIG. 5 shows a star core kernel configuration inside a system in accordance with one embodiment of the present invention.

FIG. 6 is a high-level block diagram of multiple kernels communicating over a channel in accordance with one embodiment of the present invention.

FIG. 7 shows shared memory for communicating between kernel schedulers in accordance with one embodiment of the present invention.

FIG. 8 shows a kernel scheduler providing a filter, for the acquisition of resource processes, in accordance with one embodiment of the present invention.

FIG. 9 shows a KOS in a star configuration, configured to assign processes to multiple resources.

FIG. 10 is a flow diagram showing how embodiments of the present invention deploy the functions of an operating system, in accordance with one embodiment of the present invention.

FIG. 11 shows a kernel scheduler in accordance with one embodiment of the present invention, signaling encoded protocols.

FIG. 12 is a block diagram illustrating how processes communicate through a communications port in accordance with embodiments of the present invention.

FIG. 13 shows a table mapping resources to operating systems in accordance with one embodiment of the present invention.

FIG. 14 illustrates separate kernel schedulers exchanging resource information using shared memory.

FIGS. 15A-C show tables in each of multiple operating systems, showing the status of the remaining operating systems.

FIG. 16 shows resource information used and exchanged by separate kernel schedulers in accordance with one embodiment of the present invention.

FIG. 17 is a high-level diagram illustrating how separate kernel schedulers exchange resource information in accordance with one embodiment of the present invention.

FIG. 18 is a high-level diagram showing how a process is assigned to a resource through an operating system kernel in accordance with one embodiment of the present invention.

FIG. 19 is a high-level block diagram of a command kernel, its relationship manager, and three resources.

FIG. 20 shows a process table storing process identifiers, the resources to which they are assigned, and the priority of the processes, in accordance with one embodiment of the present invention.

FIG. 21 shows the steps of a method for assigning a resource to an operating system in accordance with one embodiment of the present invention.

FIG. 22 is a flow chart of a method of using criteria to assign a process to an operating system kernel in accordance with one embodiment of the present invention.

FIG. 23 is a flow sequence showing assigning processes to operating systems in accordance with one embodiment of the present invention.

### DETAILED DESCRIPTION OF THE EMBODIMENTS

In accordance with the present invention, multiple operating systems run in tandem, sharing the allocating resources to processes requesting them, thereby reducing bottlenecks and other symptoms of resource contention. In one embodiment, resources are allocated centrally, using a central kernel operating scheduler that coordinates allocating operating systems with resources to processes requesting them. In another embodiment, resources are supplied in a peer-to-peer manner, with operating systems coordinating the distribution of resources themselves. In this embodiment, the operating systems communicate using well-established protocols.

In accordance with the present invention, some of the operating systems executing on a computing system are specialized for performing specific tasks. Operating systems that are specialized in carrying out requests for certain resource allocations, and upon receipt of a request for a resource that has other requests backlogged, overflowing request are simply queued by the resource Operating System rather than by a centralized Operating System.

### Process Management

The main task of a kernel is to allow the execution of applications and support them with features such as hardware abstractions. A process defines which memory portions the application can access. (For this introduction, process, application and program are used as synonymous.) Kernel process management must take into account the hardware built-in equipment for memory protection.

To run an application, a kernel typically sets up an address space for the application, loads the file containing the application's code into memory (perhaps via demand paging), sets up a stack for the program and branches to a given location inside the program, thus starting its execution.

Multi-tasking kernels are able to give the user the illusion that the number of processes being run simultaneously on the computer is higher than the maximum number of processes the computer is physically able to run simultaneously. Typically, the number of processes a system may run simultaneously is equal to the number of CPUs installed (however this may not be the case if the processors support simultaneous multithreading).

In a pre-emptive multitasking system, the kernel will give every program a slice of time and switch from process to process so quickly that it will appear to the user as if these processes were being executed simultaneously. The kernel uses scheduling algorithms to determine which process is running next and how much time it will be given. The algorithm chosen may allow for some processes to have higher priority than others. The kernel generally also provides these processes a way to communicate; this is known as inter-process communication (IPC) and the main approaches are shared memory, message passing and remote procedure calls.

Other systems (particularly on smaller, less powerful computers) may provide co-operative multitasking, where each process is allowed to run uninterrupted until it makes a special request that tells the kernel it may switch to another process. Such requests are known as “yielding”, and typically occur in response to requests for interprocess communication, or for waiting for an event to occur. Older versions of Windows and Mac OS both used co-operative multitasking but switched to pre-emptive schemes as the power of the computers to which they were targeted grew.

The operating system might also support multiprocessing (SMP or Non-Uniform Memory Access); in that case, different programs and threads may run on different processors. A kernel for such a system must be designed to be re-entrant, meaning that it may safely run two different parts of its code simultaneously. This typically means providing synchronization mechanisms (such as spinlocks) to ensure that no two processors attempt to modify the same data at the same time.

### Memory Management

Operating Systems in general are imbued with a kernel, a group of centralized control programs that run as the central core of the computer. Included among these control programs is a scheduler program responsible for scheduling the next process in-line for CPU time. The present invention uses multiple operating systems running atop multiple CPUs, one per CPU. Each operating system has a specialized kernel which has a unique scheduler program called the Kernel Operational Scheduler, (KOS). Every KOS has the ability to configure itself during initialization to “sysgen” a binary copy of the Operating System kernel for every CPU on board the computer system. (“Sysgen” refers to creating particular and uniquely specified operating system or other program by combining separate software components.) Once each kernel is in place and tied to each CPU, the KOS schedulers establish communication between each kernel and determine what kernel will control which resources.

### Kernel-Wide Design Approaches

Naturally, the above listed tasks and features can be provided in many ways that differ from each other in design and implementation.

The principle of separation of mechanism and policy is the substantial difference between the philosophy of micro and monolithic kernels. Here a mechanism is the support that allows the implementation of many different policies, while a policy is a particular “mode of operation.” In minimal microkernel just some very basic policies are included, and its mechanisms allow what is running on top of the kernel (the remaining part of the operating system and the other applications) to decide which policies to adopt (as memory management, high level process scheduling, file system management, etc.). A monolithic kernel instead tends to include many policies, therefore restricting the rest of the system to rely on them. The failure to properly fulfill this separation is one of the major causes of the lack of substantial innovation in existing operating systems, a problem common in computer architecture. The monolithic design is induced by the “kernel mode”/“user mode” architectural approach to protection (technically called hierarchical protection domains), which is common in conventional commercial system. In fact, every module needing protection is therefore preferably included into the kernel. This link between monolithic design and “privileged mode” can be reconducted to the key issue of mechanism-policy separation; in fact the “privileged mode” architectural approach melts together the protection mechanism with the security policies, while the major alternative architectural approach, capability-based addressing, clearly distinguishes between the two, leading naturally to a microkernel design (see Separation of protection and security).

While monolithic kernels execute all of their code in the same address space (kernel space) microkernels try to run most of their services in user space, aiming to improve maintainability and modularity of the codebase. Most kernels do not fit exactly into one of these categories, but are rather found in between these two designs. These are called hybrid kernels. More exotic designs such as nanokernels and exokernels are available, but are seldom used for production systems. The Xen hypervisor, for example, is an exokernel.

### Monolithic Kernels

### Diagram of Monolithic Kernels

In a monolithic kernel, all OS services run along with the main kernel thread, thus also residing in the same memory area. This approach provides rich and powerful hardware access. Some developers, such as UNIX developer Ken Thompson, maintain that monolithic systems are easier to design and implement than other solutions. The main disadvantages of monolithic kernels are the dependencies between system components—a bug in a device driver might crash the entire system—and the fact that large kernels can become very difficult to maintain.

### Microkernels

In the microkernel approach, the kernel itself provides only basic functionality that allows the execution of servers, separate programs that assume former kernel functions, such as device drivers, GUI servers, etc.

The microkernel approach consists of defining a simple abstraction over the hardware, with a set of primitives or system calls to implement minimal OS services such as memory management, multitasking, and inter-process communication. Other services, including those normally provided by the kernel such as networking, are implemented in user-space programs, referred to as servers. Microkernels are easier to maintain than monolithic kernels, but the large number of system calls and context switches might slow down the system because they typically generate more overhead than plain function calls.

A microkernel allows the implementation of the remaining part of the operating system as a normal application program written in a high-level language, and the use of different operating systems on top of the same unchanged kernel. It is also possible to dynamically switch among operating systems and to have more than one active simultaneously.

### Monolithic Kernels vs Microkernels

As the computer kernel grows, a number of problems become evident. One of the most obvious is that the memory footprint increases. This is mitigated to some degree by perfecting the virtual memory system, but not all computer architectures have virtual memory support. To reduce the kernel's footprint, extensive editing has to be performed to carefully remove unneeded code, which can be very difficult with non-obvious interdependencies between parts of a kernel with millions of lines of code. Due to the problems that monolithic kernels pose, they were considered obsolete by the early 1990s. As a result, the design of Linux using a monolithic kernel rather than a microkernel was the topic of a famous flame war between Linus Torvalds and Andrew Tanenbaum. There is merit on both sides of the argument presented in the Tanenbaum/Torvalds debate. Some, including early UNIX developer Ken Thompson, argued that while microkernel designs were more aesthetically appealing, monolithic kernels were easier to implement. However, a bug in a monolithic system usually crashes the entire system, while this does not happen in a microkernel with servers running apart from the main thread. Monolithic kernel proponents reason that incorrect code does not belong in a kernel, and that microkernels offer little advantage over correct code. Microkernels are often used in embedded robotic or medical computers where crash tolerance is important and most of the OS components reside in their own private, protected memory space. This is impossible with monolithic kernels, even with modern module-loading ones.

### Performances

Monolithic kernels are designed to have all of their code in the same address space (kernel space) to increase the performance of the system. Some developers, such as UNIX developer Ken Thompson, maintain that monolithic systems are extremely efficient if well-written. The monolithic model tends to be more efficient through the use of shared kernel memory, rather than the slower Interprocess communication (IPC) system of microkernel designs, which is typically based on message passing.

The performance of microkernels constructed in the 1980s and early 1990s was poor. The studies that empirically measured the performance of some of those particular microkernels, did not analyze the reasons of such inefficiency. The explanations to those performances were left to “folklore,” with the common and then unproved beliefs that they were due to the increased frequency of switches from “kernel-mode” to “user-mode” (but such a hierarchical design of protection is not inherent in microkernels) to the increased frequency of inter-process communication (but IPC can be implemented an order of magnitude faster than previously believed), and to the increased frequency of context switches. In fact, as guessed in 1995, the reasons for those poor performances might as well have been: (1) an actual inefficiency of the whole microkernel approach, (2) the particular concepts implemented in those microkernels, and (3) the particular implementation of those concepts. Therefore it remained to be studied if the solution to build an efficient microkernel was, unlike previous attempts, to apply the correct construction techniques.

On the other end, the hierarchical protection domain architecture that leads to the design of a monolithic kernel has a significant performance drawback each time there is an interaction between different levels of protection (i.e. when a process has to manipulate a data structure both in “user mode” and “supervisor mode”), since this requires message copying by value. By the mid-1990s, most researchers had abandoned the belief that careful tuning could reduce this overhead dramatically, but recently, newer microkernels, have been optimized for performance.

### Hybrid Kernels

The hybrid kernel approach tries to combine the speed and simpler design of a monolithic kernel with the modularity and execution safety of a microkernel.

Hybrid kernels are essentially a compromise between the monolithic kernel approach and the microkernel system. This implies running some services (such as the network stack or the file system) in kernel space to reduce the performance overhead of a traditional microkernel, but still running kernel code (such as device drivers) as servers in user space.

### Nanokernels

A nanokernel delegates virtually all services, including even the most basic ones like interrupt controllers or the timer, to device drivers to make the kernel memory requirement even smaller than a traditional microkernel.

### Exokernels

An exokernel is a type of kernel that does not abstract hardware into theoretical models. Instead it allocates physical hardware resources, such as processor time, memory pages, and disk blocks, to different programs. A program running on an exokernel can link to a library operating system that uses the exokernel to simulate the abstractions of a well-known OS, or it can develop application-specific abstractions for better performance.

### Scheduling

Scheduling is a key concept in computer multitasking and multiprocessing operating system design, and in real-time operating system design. It refers to the way processes are assigned priorities in a priority queue. This assignment is carried out by software known as a scheduler.

In real-time environments, such as mobile devices for automatic control in industry (for example robotics), the scheduler must also ensure that processes can meet deadlines; this is crucial for keeping the system stable. Scheduled tasks are sent to mobile devices and managed through an administrative back end.

### Types of Operating System Schedulers

Operating systems may feature up to 3 distinct types of schedulers: a long-term scheduler (also known as an “admission scheduler”), a mid-term or medium-term scheduler and a short-term scheduler (also known as a “dispatcher”).

The long-term, or admission, scheduler decides which jobs or processes are to be admitted to the ready queue; that is, when an attempt is made to execute a program, its admission to the set of currently executing processes is either authorized or delayed by the long-term scheduler. Thus, this scheduler dictates what processes are to run on a system and the degree of concurrency to be supported at any one time—i.e., whether a high or low amount of processes are to be executed concurrently, and how the split between I/O intensive and CPU intensive processes is to be handled. Typically for a desktop computer, there is no long-term scheduler as such, and processes are admitted to the system automatically. However this type of scheduling is very important for a real time system, as the system's ability to meet process deadlines may be compromised by the slowdowns and contention resulting from the admission of more processes than the system can safely handle.

The mid-term scheduler, present in all systems with virtual memory, temporarily removes processes from main memory and places them on secondary memory (such as a disk drive) or vice versa. This is commonly referred to as “swapping out” or “swapping in” (also incorrectly referred as “paging out” or “paging in”). The mid-term scheduler may decide to swap out a process which has not been active for some time, or a process which has a low priority, or a process which is page faulting frequently, or a process which is taking up a large amount of memory in order to free up main memory for other processes, swapping the process back in later when more memory is available, or when the process has been unblocked and is no longer waiting for a resource.

In many systems today (those that support mapping virtual address space to secondary storage other than the swap file), the mid-term scheduler may actually perform the role of the long-term scheduler, by treating binaries as “swapped out processes” upon their execution. In this way, when a segment of the binary is required, it can be swapped in on demand, or “lazy loaded”.

The short-term scheduler (also known as the “dispatcher”) decides which of the ready, in-memory processes are to be executed (allocated a CPU) next following a clock interrupt, an I/O interrupt, an operating system call or another form of signal. Thus the short-term scheduler makes scheduling decisions much more frequently than the long-term or mid-term schedulers—a scheduling decision will at a minimum have to be made after every time slice, and these are very short. This scheduler can be preemptive, implying that it is capable of forcibly removing processes from a CPU when it decides to allocate that CPU to another process, or non-preemptive, in which case the scheduler is unable to “force” processes off the CPU.

### Scheduling Disciplines

Scheduling disciplines are algorithms used for distributing resources among parties which simultaneously and asynchronously request them. Scheduling disciplines are used in routers (to handle packet traffic) as well as in operating systems (to share CPU time among threads and processes).

The main purposes of scheduling algorithms are to minimize resource starvation and to ensure fairness among the parties utilizing the resources.

### Operating System Scheduler Implementations

Different computer operating systems implement different scheduling schemes. Very early MS-DOS and Microsoft Windows systems were non-multitasking, and as such did not feature a scheduler. Windows 3.1-based operating systems use a simple non-preemptive scheduler which requires programmers to instruct their processes to “yield” (give up the CPU) in order for other processes to gain some CPU time. This provided primitive support for multitasking, but did not provide more advanced scheduling options.

Windows NT 4.0-based operating systems use a multilevel feedback queue. Priorities in Windows NT 4.0 based systems range from 1 through to 31, with priorities 1 through 15 being “normal” priorities and priorities 16 through 31 being soft realtime priorities, requiring privileges to be assigned. Users can select 5 of these priorities to assign to a running application from the Task Manager application, or through thread management APIs.

Early Unix implementations use a scheduler with multilevel feedback queues with round robin selections within each Feedback Queue. In this system, processes begin in a high priority queue (giving a quick response time to new processes, such as those involved in a single mouse movement or keystroke), and as they spend more time within the system, they are preempted multiple times and placed in lower priority queues. Unfortunately under this system older processes may be starved of CPU time by a continual influx of new processes, although if a system is unable to deal with new processes faster than they arrive, starvation is inevitable anyway. Process priorities could be explicitly set under Unix to one of 40 values, although most modern Unix systems have a higher range of priorities available (Solaris has 160). Instead of the Windows NT 4.0 solution to low priority process starvation (bumping a process to the front of the round robin queue should it be starving), early Unix systems used a more subtle aging system, to slowly increase the priority of a starving process until it was executed, whereupon its priority would be reset to whatever it was before it started starving.

The Linux kernel had been using an O(1) scheduler until 2.6.23, at which point it is switching over to the Completely Fair Scheduler.

### Scheduling Algorithm

In computer science, a scheduling algorithm is the method by which threads or processes are given access to system resources, usually processor time. This is usually done to load balance a system effectively. The need for a scheduling algorithm arises from the requirement for most modern systems to perform multitasking, or execute more than one process at a time. Scheduling algorithms are generally only used in a time slice multiplexing kernel. The reason is that in order to effectively load balance a system, the kernel must be able to suspend execution of threads forcibly in order to begin execution of the next thread.

The algorithm used may be as simple as round-robin in which each process is given equal time (for instance 1 ms, usually between 1 ms and 100 ms) in a cycling list. So, process A executes for 1 ms, then process B, then process C, then back to process A.

More advanced algorithms take into account process priority, or the importance of the process. This allows some processes to use more time than other processes. It should be noted that the kernel always uses whatever resources it needs to ensure proper functioning of the system, and so can be said to have infinite priority. In Symmetric Multiprocessor (SMP) systems, processor affinity is considered to increase overall system performance, even if it may cause a process itself to run more slowly. This generally improves performance by reducing cache thrashing.

### I/O Scheduling

This section is about I/O Scheduling, which should not be confused with process scheduling. “I/O Scheduling” is the term used to describe the method computer operating systems use to decide the order that blocked I/O operations will be submitted to the disk subsystem. I/O Scheduling is sometimes called “disk scheduling.”

### Purpose

I/O schedulers can have many purposes depending on the goal of the I/O scheduler, some common goals are:
To minimize time wasted by hard disk seeks.
To prioritize certain processes' I/O requests.
To give a share of the disk bandwidth to each running process.
To guarantee that certain requests will be issued before a particular deadline.

### Implementation

I/O Scheduling usually has to work with hard disks which share the property that there is a long access time for requests that are far away from the current position of the disk head (this operation is called a seek). To minimize the effect this has on system performance, most I/O schedulers implement a variant of the elevator algorithm which re-orders the incoming randomly ordered requests into the order in which they will be found on the disk.

### Common Disk Scheduling Disciplines

Random Scheduling (RSS)
First In, First Out (FIFO), also known as First Come First Served (FCFS)
Last In, First Out (LIFO)
Shortest seek first, also known as Shortest Seek/Service Time First (SSTF)
Elevator algorithm, also known as SCAN (including its variants, C-SCAN, LOOK, and C-LOOK)
N-Step-SCAN SCAN of N records at a time
FSCAN, -Step-SCAN where N equals queue size at start of the SCAN cycle.
Completely Fair Queuing (Linux)
Anticipatory scheduling

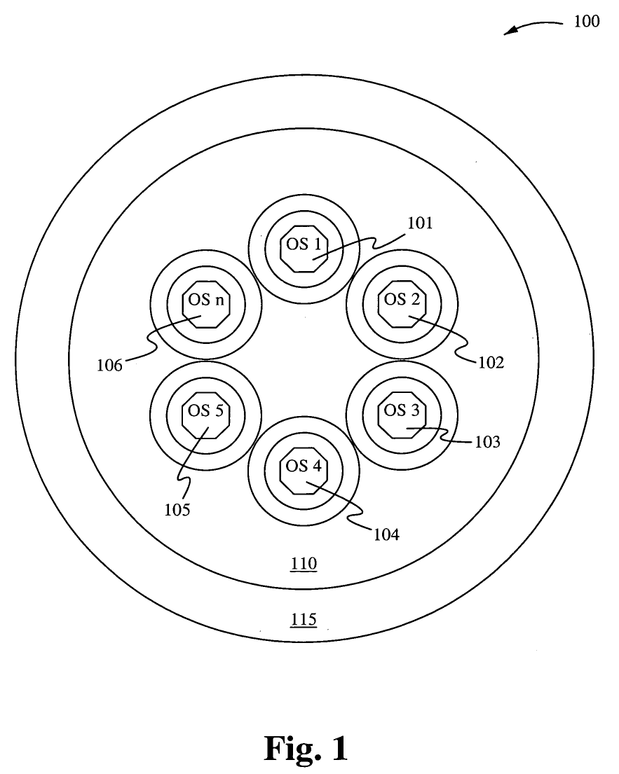

FIG. 1 schematically illustrates a KOS scheduler operating system 100 in accordance with one embodiment of the present invention. The KOS scheduler operating system 100 comprises multiple operating systems 101-106 executing in a single memory, all interfacing with applications indicated by the shell 115.

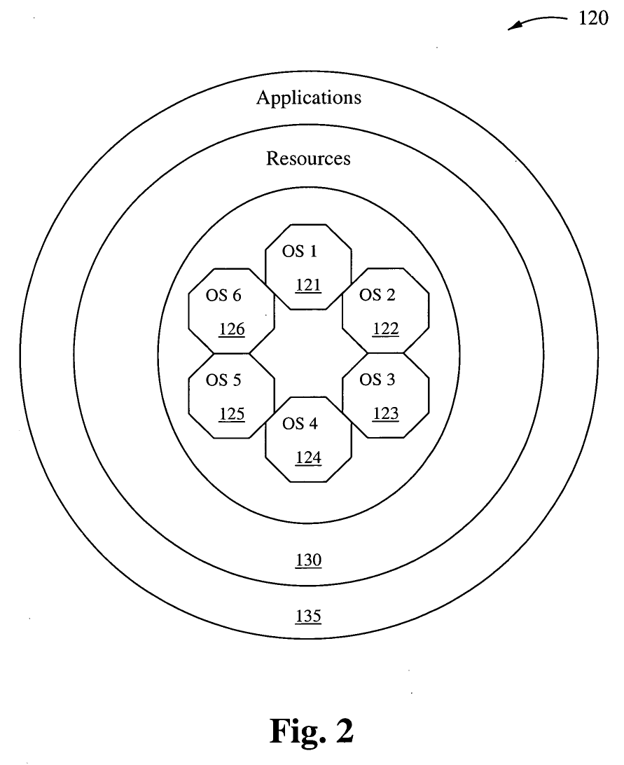

FIG. 2 schematically illustrates a KOS scheduler operating system 120 in accordance with another embodiment of the present invention. The KOS scheduler operating system 120 comprises multiple operating systems 121-126 executing in a single memory, interfacing with resources indicated by the shell 130, which in turn interfaces with applications indicated by the shell 135.

### Multi-OS KOS Systems

Multi-tasking, kernels are able to give the user the illusion that the number of processes being run simultaneously on the computer is higher than the maximum number of processes the computer is physically able to run simultaneously. The present invention actually suggests that this illusion is eliminated by the increase in the number of processors from one to two or more, and the KOS design which increases the number of operating systems actually on board a computer system all working simultaneously together using a specially designed scheduler software to communicate, schedule, delegated, route and outsource events as events indicate requests for resources. Typically, the number of processes a system may run simultaneously is equal to the number of CPUs installed (however this may not be the case if the processors support simultaneous multithreading). Preferred embodiments of the present invention require that there be more than one CPU installed, whereas it suggests that the number of operating systems simultaneously working in concert should equal the number of CPUs installed for maximum performance. UNIX-KOS designs also suggest that multithreading continue to be implemented within each operating system kernel, while leaving the KOS scheduler to communicate, outsource, route application programs to and from each of the installed operating systems according to the resources required by the application, and resources supported by each operating system.

### The KOS Concept

A distributed kernel operating scheduler (KOS) is a distributed operating system for operating in a synchronous manner with other kernel operating schedulers. Each KOS operates in parallel with other similar KOSs, and although there may be two or more operating inside any given computer system environment and resident to any particular computer with two or more CPUs, the environment is considered a single computer. In some nomenclatures distributed computing may be defined as the distribution of computing resources across many different computer platforms and all working together in concert under one operational theme. A KOS is similar yet different only in the sense that distributed KOSs are within a single computer system environment operating in very close proximity to each other and as a single computer. Each KOS is inside a single kernel. Each kernel has a single scheduler which is replaced by a KOS before the KOS is designed with communication facilities to communicate with other similar KOSs of its type to schedule events.

Processing of data can be broken down into a series of events, by which each event requires certain computer resources in order to achieve completion. A scheduler is the single most responsible program inside a kernel which has the task of allocating CPU time, resources and priority to an event. Thus, when scheduling the resource of CPU time under a time-sharing scenario, an event is allowed other resources such as memory, temporary I/O bus priority, etc., and whatever is required for completion of the particular event. In accordance with the present invention, a KOS is a kernel operations scheduler, whereas there are multiple KOSs per single system and each runs simultaneously and conducts execution on simultaneous events which require computer resources to complete. Yet, each KOS may require similar resources whereas such resources are controlled by semaphores within the kernel environment space or within a share portion of memory when such resources may be limited or in short supply. KOS being a distributed OS, and at its core, a scheduler, is distributed computing tied to generic CPU hardware, where each has a unique id at initialization, and whereas such an ID is assigned to each KOS.

### Unix System IPC

### The IPC Facilities and Protocol Stacks

The IPC Facilities and Protocol Stacks have been resident to the UNIX construct and are already integrated as utilities. These utilities are used to provide communication between operating systems under the present construction.

Table 1 maps KOS types to specific resources that they support. In reference to information in the Table 1, the first seven forms of IPC are used as communication between processes within the local kernel and scheduler operating system, and the last two are used to communicate between operating systems on the same computer but distributed across CPUs on the same computer system.

TABLE 1

| | IPC Types | | | | | | |
|---|---|---|---|---|---|---|---|
| | | | Mac | | | | |
| | Free BSD | Linux | OS X | Solaris | AIX | IRIX | HP-UX |
| Half-duplex | x | | x | | | x | x |
| pipes FIFO | | | | | | | |
| Full-Duplex | x | | x | | | x | x |
| pipes | | | | | | | |
| Named Full- | | x | | x | x | x | |
| Duplex | | | | | | | |
| pipes | | | | | | | |
| Named Full- | | | | x | x | x | |
| Duplex | | | | | | | |
| Pipes | | | | | | | |
| Mounted | | | | | | | |
| STREAMS- | | | | | | | |
| based pipes | | | | | | | |
| Messages | | | | x | x | x | x |
| queues | | | | | | | |
| Sempahores | x | | x | x | x | x | x |
| Shared | x | | x | x | x | | x |
| memory | | | | | | | |
| Sockets | x | x | x | | | | x |
| STREAMS | | x | | x | | | x |

Linux support for STREAMS is available in a separate, optional package called “LIS.”

The first seven forms of IPC in Table 1 are usually restricted to IPC between processes on the same host operating system. The final two rows—sockets and STREAMS—are the only two that are generally supported for IPC between processes on different hosts.

### The Kernel Scheduler

The Kernel Scheduler provides a feature which filters and selects the resources required to determine where the current processing should occur. Each CPU, for example is generally a general purpose CPU, whereas each KOS is more specific. A portion of memory is shared between each KOS such that pointers and file descriptors are passed between each KOS instead of actual file data. The IPC facilities are used to allow certain processes to communicate across CPUs, across KOSs thus to convey required transactions in the form of transactional protocols between processes.

One embodiment of the present invention allows an application such as a speech synthesizer to run uninterrupted and thus consistently on a particular CPU using a KOS to take advantage of exclusivity of I/O resources while barring interrupts, queues and having to be swapped out to allow preemption. In accordance with another embodiment, an application is a video stream from a DVD format, whereas a video stream is allowed to run utilizing a particular CPU, memory, and KOS without facing a centralized scheduler that will be faced with scenarios where it must swap out from time to time to achieve optimality between processes within a centralized OS.

### Shared Memory

Shared memory is very much an integral part of the present UNIX operating system construct, and although currently provided for use in a particular convention, it can also be implemented in a particular manner to serve the purpose of distributed OS under KOS, the present convention. In accordance with one embodiment of the present invention, each operating system kernel is imbued with a scheduler, whereby the scheduler becomes the integral and key component player in each kernel. Each distributed operating system's KOS becomes a KOS scheduler. There are four such operating systems with four such schedulers, whereas each scheduler has been designed so that it communicates with other schedulers in other operating systems. The communications are designed to allow the sharing of resources of other schedulers. Each scheduler has attached to it, a specific set of resources, which may include typical computer resources such as disk access, Internet access, movie DVD players, Music DVD, keyboard communications, and the like. These resources are attached to a given set of operating system kernel schedulers, each of which is able, at a specific given point, to outsource or off-load specific processing that requires special resources to other KOS operating on other CPUs. Each Scheduler is assigned a portion of memory. It and its kernel are mapped into main memory along with the other KOSs, and their CPUs.

### The TCP/IP Protocol Suite

TCP and IP local can be used as resources for transporting data and application files between CPUs and KOS. Each KOS is local to its own respective CPU, which may or may not have independent memory mapped I/O. In one embodiment, the TCP Port loop-back facility resident to many UNIX Systems is used, configured to send and receive data files between other operating systems under the KOS system configuration.

### UDP Protocol Mechanics

User datagram (UDP) user defined protocols are part of the TCP/IP protocol suite and can be configured to import and export data files between independent CPUs and operating systems under the KOS convention. UDP can also be set up to pass messages between independent CPU resident operating systems.

### I/O (Input/Output) CPU Based Operating Systems

An I/O (input/output) bus controller functions as a special purpose device but also directs task specific tasks that involve disk operations, or the handling of channel data for input or output from main memory. Such a controller can easily be replaced by a general purpose CPU, whereas it would provide more functional capabilities and allow resident software such as a KOS to provide reconfigurable applications rather than those hard wired to the specific controller. In embodiments of the present invention, the I/O CPU or Processor would have resident to it, an I/O operating system with a scheduler specifically designed to handle only the I/O functions of the system at large. This would allow bus data to avoid bottlenecks at the controller, inasmuch as such a CPU would have the ability of forming I/O queues under necessary conditions.

Table 2 lists specific KOS types and the specific resources that each type is specialized to support. For example, Table 2 shows that a Media OS (column 1, row 5) is specialized to perform Video I/O, such as when running a CD DVD (column 4, row 5). Similarly, Table 2 shows that a Disk OS (column 1, row 7) is specialized to perform Disk I/O, such as when communicating over a channel bus (column 2, row 7).

TABLE 2

| | | | | Memory | | | |
|---|---|---|---|---|---|---|---|
| KOS Types | Disk I/O | USB | Video I/O | Mgmt | Keyboard | Sound | Network |
| Central OS | | | | Main | | | |
| | | | | memory | | | |
| Printing OS | | Print | | | | Voice | |
| Keyboard | | | | | Speech | | |
| OS | | | | | | | |
| Media OS | | | CD DVD | | | | |
| Video OS | | | Screens | | | | |
| Disk OS | Channel bus | extend | Monitor | | | | |
| Media OS | | | | | | | |
| Network OS | | | | | | | |

One embodiment of the present invention deploys the use of a construct where the functions of an operating system are based upon the concept of being portable, can have its functionality divided into threads whereas each thread operates independently of the others. In that way, each thread has the ability to independently carry out operations under different and separate schedulers.

The various process states, displayed in a state diagram, with arrows indicating possible transitions between states-as can be seen, some processes are stored in main memory, and some are stored in secondary (virtual) memory.

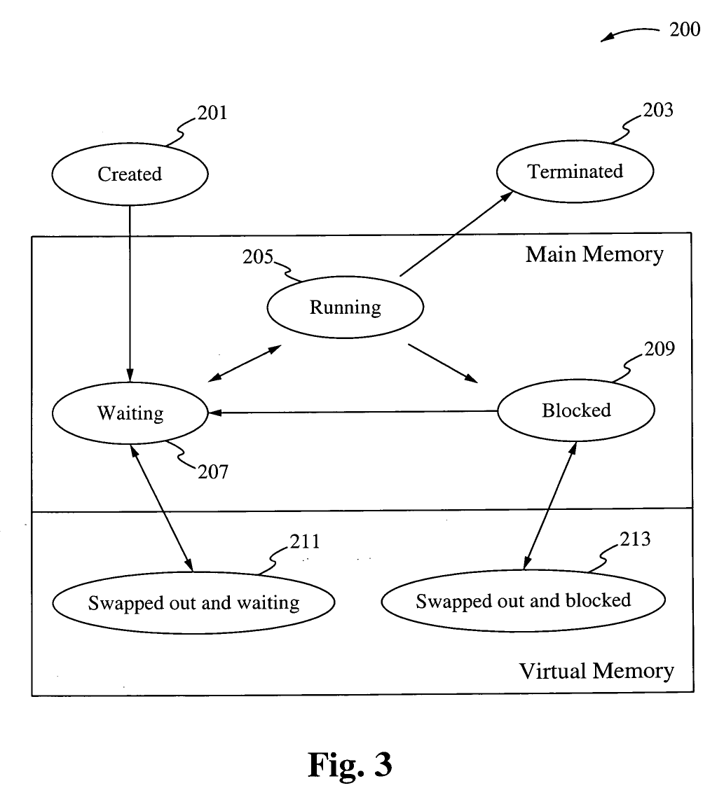

FIG. 3 shows a state diagram 200 for Kernel process scheduling. The state diagram includes a “Created” state 201, a “Waiting” state 207, a “Running” state 205, a “Blocked” state 209, a “Swapped out and blocked” state 213, a “Swapped out and waiting” state 211, and a “terminated” state 203. These states are discussed fully below.

Embodiments of the present invention eliminate the need for the “Swapped Out and Waiting, Swapped Out and Blocked” state by making multiple operating systems work in tandem with each other, and become more specialized with the resources that they manage, thus using the wait states as queues for incoming “received” outsource or out-routed events. Embodiments of the present invention leave the abilities to deploy multithreading, Swapped Out Waiting/Blocked to be deployed as facilities for carrying out other implementations of the present design.

### Primary Process States

The following typical process states are possible on computer systems of all kinds. In most of these states, processes are “stored” on main memory.

### Created

(Also called “new.”) When a process is first created, it occupies the “created” or “new” state. In this state, the process awaits admission to the “ready” state. This admission will be approved or delayed by a long-term, or admission, scheduler. Typically in most desktop computer systems, this admission will be approved automatically, however for real time operating systems this admission may be delayed. In a real-time operating system (RTOS), admitting too many processes to the “ready” state may lead to oversaturation and over contention for the system's resources, leading to an inability to meet process deadlines.

### Ready

(Also called “waiting” or “runnable.”) A “ready” or “waiting” process has been loaded into main memory and is awaiting execution on a CPU (to be context switched onto the CPU by the dispatcher, or short-term scheduler). There may be many “ready” processes at any one point of the system's execution. For example, in a one-processor system, only one process can be executing at any one time, and all other “concurrently executing” processes are waiting for execution.

### Running

(Also called “active” or “executing.”) A “running,” “executing,” or “active” process is a process that is currently executing on a CPU. From this state the process may exceed its allocated time slice and be context switched out and back to “ready” by the operating system. It may indicate that it has finished and be terminated or it may block on some needed resource (such as an input/output resource) and be moved to a “blocked” state.

### Blocked

(Also called “sleeping.”) Should a process “block” on a resource (such as a file, a semaphore or a device), it will be removed from the CPU (as a blocked process cannot continue execution) and will be in the blocked state. The process will remain “blocked” until its resource becomes available, which can unfortunately lead to deadlock. From the blocked state, the operating system may notify the process of the availability of the resource it is blocking on (the operating system itself may be alerted to the resource availability by an interrupt). Once the operating system is aware that a process is no longer blocking, the process is again “ready” and can from there be dispatched to its “running” state. From there the process may make use of its newly available resource.

### Terminated

A process may be terminated, either from the “running” state by completing its execution or by explicitly being killed. In either of these cases, the process moves to the “terminated” state. If a process is not removed from memory after entering this state, this state may also be called zombie.

### Additional Process States

Two additional states are available for processes in systems that support virtual memory. In both of these states, processes are “stored” on secondary memory (typically a hard disk).

### Swapped Out and Waiting

(Also called “suspended and waiting.”) In systems that support virtual memory, a process may be swapped out, that is removed from main memory and placed in virtual memory by the mid-term scheduler. From there the process may be swapped back into the waiting state.

### Swapped Out and Blocked

(Also called “suspended and blocked.”) Processes that are blocked may also be swapped out. In this event the process is both swapped out and blocked, and may be swapped back in again under the same circumstances as a swapped out and waiting process (although in this case, the process will move to the blocked state and may still be waiting for a resource to become available).

### Scheduling

Multitasking kernels (like Linux) allow more than one process to exist at any given time, and each process is allowed to run as if it were the only process on the system. Processes do not need to be aware of any other processes unless they are explicitly designed to be. This makes programs easier to develop, maintain, and port. Though each CPU in a system is able to execute only one thread within a process at a time, many threads from many processes appear to be executing at the same time. This is because threads are scheduled to run for very short periods of time and then other threads are given a chance to run. A kernel's scheduler enforces a thread scheduling policy, including when, for how long, and in some cases where (on SMP systems) threads can execute. Normally the scheduler runs in its own thread, which is woken up by a timer interrupt. Otherwise it is invoked via a system call or another kernel thread that wishes to yield the CPU. A thread will be allowed to execute for a certain amount of time, then a context switch to the scheduler thread will occur, followed by another context switch to a thread of the scheduler's choice. This cycle continues, and in this way a certain policy for CPU usage is carried out.

### CPU- and I/O-bound Threads

Threads of execution tend to be either CPU-bound or I/O-bound (Input/Output bound). That is, some threads spend a lot of time using the CPU to perform computations, and others spend a lot of time waiting for relatively slow I/O operations to complete. For example, a thread sequencing DNA will be CPU bound. A thread taking input for a word processing program will be I/O-bound as it spends most of its time waiting for a human to type. It is not always clear whether a thread should be considered CPU- or I/O-bound. The best that a scheduler can do is guess, if it cares at all. Many schedulers do care about whether or not a thread should be considered CPU- or I/O-bound, and thus techniques for classifying threads as one or the other are important parts of schedulers. Schedulers tend to give I/O-bound threads priority access to CPUs. Programs that accept human input tend to be I/O-bound—even the fastest typist has a considerable amount of time between each keystroke during which the program he or she is interacting with is simply waiting. It is important to give programs that interact with humans priority since a lack of speed and responsiveness is more likely to be perceived when a human is expecting an immediate response.

### The Round-Robin Scheduling Algorithm

Scheduling is the process of assigning tasks to a set of resources. It is an important concept in many areas such as computing and production processes.

It is a key concept in multitasking and multiprocessing operating system design, and in real-time operating system design. It refers to the way processes are assigned priorities in a priority queue. This assignment is carried out by software known as a scheduler.

In general-purpose operating systems, the goal of the scheduler is to balance processor loads, and prevent any one process from either monopolizing the processor or being starved for resources. In real-time environments, such as devices for automatic control in industry (for example robotics), the scheduler must also ensure that processes can meet deadlines; this is crucial for keeping the system stable.

Round-robin is the simplest scheduling algorithm for processes in an operating system. This algorithm assigns time slices to each process in equal portions and order, handling all processes as having the same priority. In prioritized scheduling systems, processes on an equal priority are often addressed in a round-robin manner. This algorithm starts at the beginning of the list of PDBs (Process Descriptor Block), giving each application in turn a chance at the CPU when time slices become available.

Round-robin scheduling has the great advantage of being easy to implement in software. Since the operating system must have a reference to the start of the list, and a reference to the current application, it can easily decide who to run next by just following the array or chain of PDBs to the next element. Once the end of the array is reached, the selection is reset back to the beginning of the array. The PDBs must be checked to ensure that a blocked application is not inadvertently selected, as that needlessly could waste CPU time, or worse, make a task think it has found its resources when in reality it should be waiting a while longer. The term “round robin” comes from the round-robin principle known from other fields, where each person takes an equal share of something in turn.

In short, each process is assigned a time interval, called its quantum, during which it is allowed to run. If the process is still running at the end of the quantum, the CPU is preempted and given to another process. If the process has blocked or finished before the quantum has elapsed, the CPU switching is done when the process blocks.

The Scheduling algorithms can be divided into two categories with respect to how they deal with clock interrupts.

### Nonpreemptive Scheduling

A scheduling discipline is nonpreemptive if, once a process has been given the CPU, it keeps the CPU. The following are some characteristics of nonpreemptive scheduling:
1. In a nonpreemptive system, short jobs are made to wait by longer jobs but the overall treatment of all processes is fair.
2. In a nonpreemptive system, response times are more predictable because incoming high priority jobs cannot displace waiting jobs.
3. In nonpreemptive scheduling a scheduler executes jobs in the following two situations:
   a. When a process switches from running state to the waiting state.
   2. When a process terminates.

### Preemptive Scheduling

A scheduling discipline is preemptive if, once a process has been given the CPU, the CPU can be taken away. The strategy of allowing processes that are logically runnable to be temporarily suspended is called Preemptive Scheduling and is in contrast to the “run to completion” method.

Round-Robin Scheduling is preemptive (at the end of a time-slice); therefore, it is effective in time-sharing environments in which the system needs to guarantee reasonable response times for interactive users.

The most interesting issue with a round-robin scheme is the length of the quantum. Setting the quantum too short causes too many context switches and lowers the CPU efficiency. On the other hand, setting the quantum too long may cause poor response time and approximates First Come First Served (FCFS). The following example illustrates this.

Assume task switching takes 2 msec. If there is a quantum of 8 msec, can we ensure very good response times. In this example, 20 users all logged in to a single CPU server; with every user making a request at the same time. Each task takes up 10 msec (8 msec quantum+2 msec overhead), and the 20th user gets a response in 200 msec (10 msec*20), ⅕ of a second.

On the other hand, the efficiency is:

Useful time total time=8 ms/10 ms=80% i.e. 20% of the CPU time is wasted on overhead.

With a 200 msec quantum, efficiency is 200 msec/202 msec=˜99%

But, the response time if 20 users make a request at once is 202*20=4040 msec or >4 seconds, which is not good. To get a full picture about what is really happening, consider the parameter definitions:
Response Time—Time for processes to complete. The OS may want to favor certain types of processes or to minimize a statistical property like average time.
Implementation Time—This includes the complexity of the algorithm and the maintenance
Overhead—Time to decide which process to schedule and to collect the data needed to make that selection
Fairness—To what extent are different users processes treated differently

So, a large quantum ensures more efficiency while a small quantum ensures a better response-time. Throughput and turnaround depend on the number of jobs in the system and I/O usage per task. Round robin is obviously fair.

In any event, the average waiting time under round-robin scheduling is often quite long—a process may use less than its time slice (e.g. blocking on a semaphore or I/O operation). Idle tasks should never get CPU except when no other task is running (it should not participate in the round robin).

Most current major operating systems run variants of round robin and maybe the most important improvement they bring are the priority classes for processes.

A simple algorithm for setting these classes is to set the priority to 1/f, where f is the fraction of the last quantum that a process used. A process that used only 2 msec of its 100 msec share would get a priority level of 50, while one that used 50 msec before blocking will get a priority level of 2. Therefore, the processes that used their entire 100 msec quantum will get the lowest priority (that would be one, on other systems, priorities are C-style [0 . . . 99], unlike Linux which sets them from 1 to 99).

There are perceivably three configurations of operating system designs for the KOS scheduler. FIG. 1 illustrates a close cluster KOS configuration where the resources are distributed along the outer perimeter as with all other conventional operating systems.

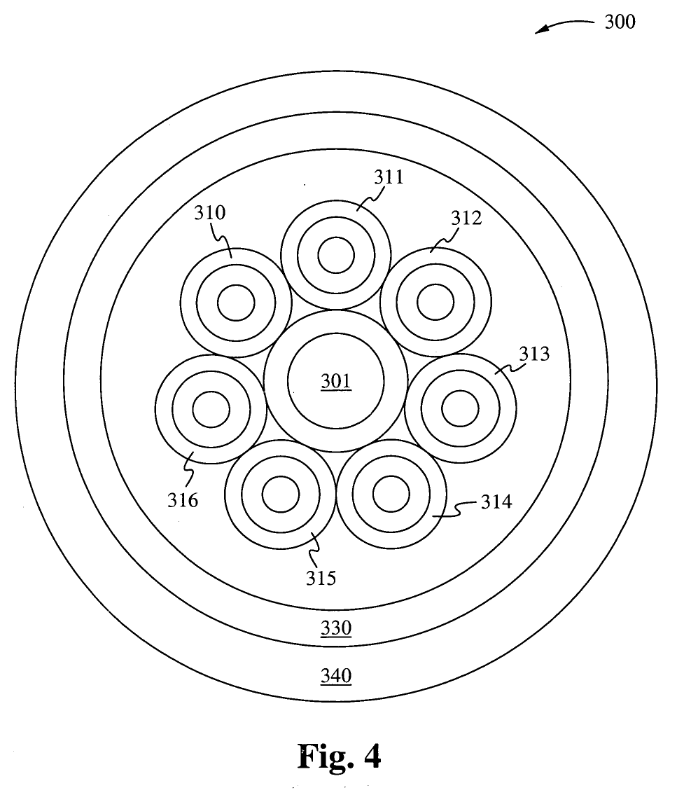

FIG. 4 illustrates a system 300 with several additional features that are possible under the KOS conceptual design. Those additional features include a central routing OS facility 301 dedicated solely to the purpose of receiving events from the input devices and routing them to the appropriate distribution OS to gain access to resources. Under this design, each operating system has a limited number of resources embedded within its memory footprint upon which it can immediately get at to obtain full resolution for each event it has been assigned. In the outer perimeter are additional resources that may be considered system resources upon which each internal OS has to share and can reserve for extended events (jobs that require extended resources to complete).

As shown in FIG. 4, the system 300 also includes multiple operating systems 310-316 surrounding the OS facility 301. The operating systems 310-316 are shown schematically as surrounded by a shell of resources 330, which in turn is surrounded by a shell of applications 340.

One method of configuration for Kernel Operating Schedulers is the Star Configuration. Under a Star Configuration, one kernel is configured to act a central dispatcher whereas the role of accepting processes from a ready state screening them for necessary resources such as extra memory allocation, stack requirements, or robust I/O traffic, etc. and dispatching the process to the appropriate operating system environment configured to support such requests. Under the star configuration, no process is ever blocked or sleeping, traffic flows using three states running, wait, and switched states only.

The Star Core Kernel Configuration inside system S₁

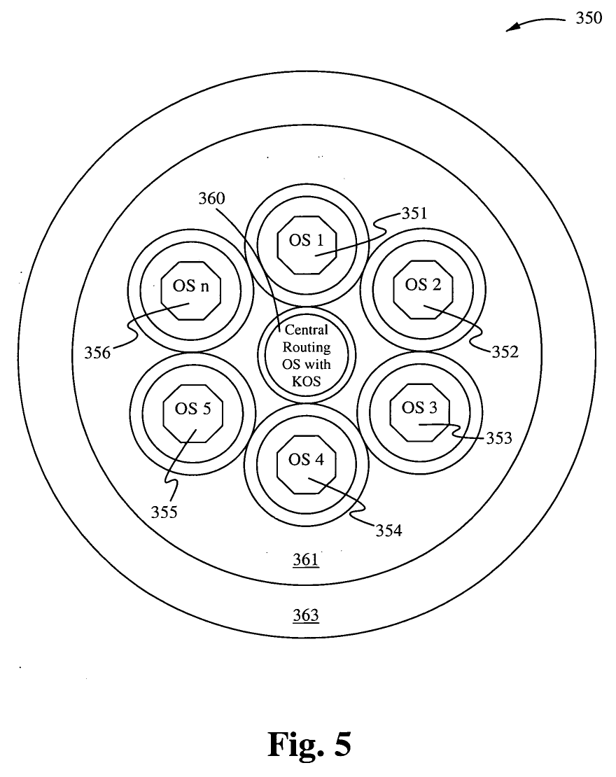

The Kernel acting as the core surrounded by n other kernels. FIG. 5 shows a Star Core Kernel configuration 350 inside a System S₁ in accordance with one embodiment of the present invention. The Configuration includes a Central Routing Operating System with KOS 360, surrounded by kernel operating systems 351-356, surrounded by a shell of applications 363. The shells surrounding each of the operating systems 351-356 correspond to resources available to each of the operating systems 351-356. The Central Routing Operating System performs the following typical process states:
1. When a process is first created within the system S₁, it occupies the new process state where it is screened for required resources (See the section on system resources.). Once the required resources have been determined, the core looks up the operating system (which may be ideally in an idle state), which is likely to meet those resource requirements such as an I/O operating system (see I/O Operating System). Once the appropriate OS has been determined, the process is moved to the switch state (instead of the Ready State normally), and upon the next cycle of the clock the process is dispatched to the appropriate operating system within system S₁.
2. The Core has a “running state” which is used to communicate with all other running states based upon processes that have been dispatched and should be currently running. The core's running state is more of a statue communication state or virtual running state whereas it does not actually run a process, but rather keeps track of all running processes within a system S and informs the console of each status.
3. The Ready State for a process that was just created is a state under the Star Core kernel which serves as a triage or screening state, whereas in any of the peripheral kernels under the star core, it serves as a waiting or runnable state just as it does under traditional process states.

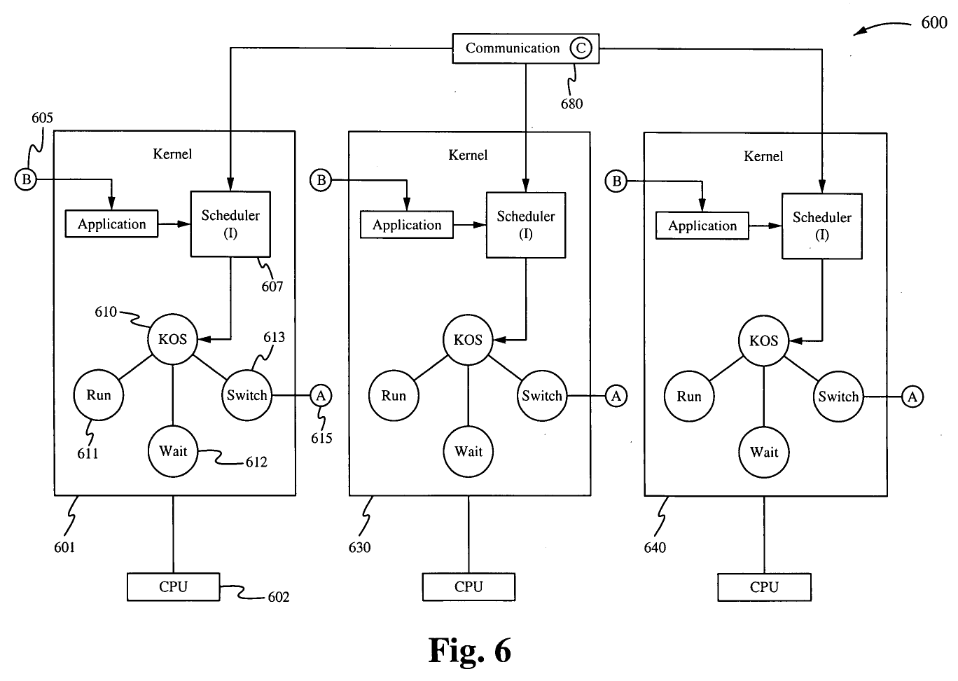

FIG. 6 is a high-level block diagram of multiple kernels 601, 630, and 640 communicating over a communication channel C 680, with each kernel having an application program A being switched out and an application program B being switched in. For example, the kernel 601 is executed by a central processing unit 602 and contains a scheduler 607, a KOS 610 having a run state 611, a wait state 612, and a switch state 613 for switching the application program A 615. FIG. 6 shows the application A 615 being switched out and the application B 605 being switched in. The kernels 630 and 640 operate similarly to the kernel 601 and will not be discussed here. The communication channel C 680 is between KOS schedulers inside kernels and across CPUs.

### Shared Memory

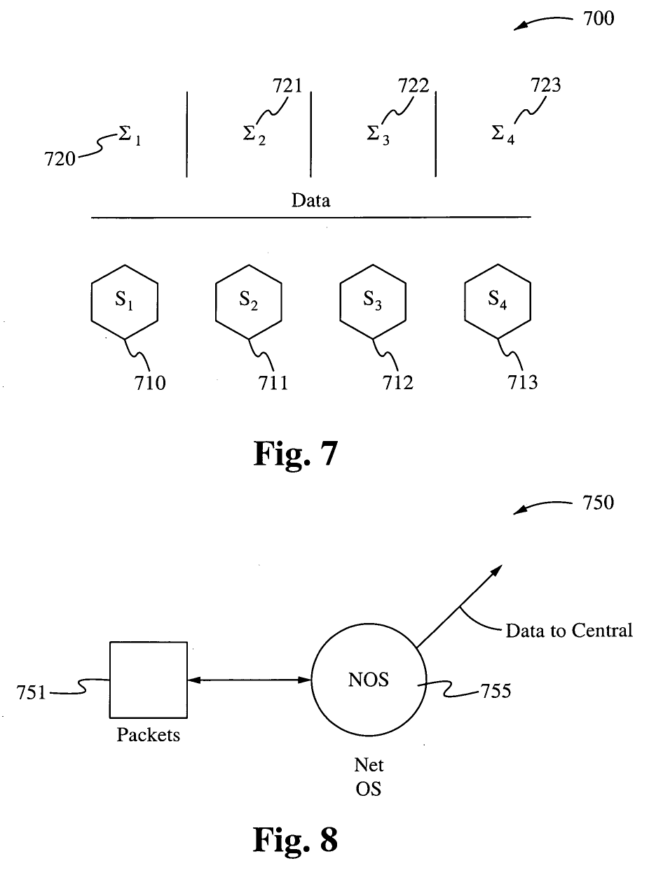

FIG. 7 illustrates a system 700 that includes shared memory indicated by Σ₁ 720, Σ₂ 721, Σ₃ 722, and Σ₄ 724, and the operating system environments 710-713. Referring to FIG. 7, shared memory is very much a part of the Unix operating system and although the abstract is currently provided for use in a particular convention it can also be implemented in a particular manner to serve the purpose of a distributed operating system in accordance with embodiments of the present invention. If each operating system kernel becomes a specialized scheduler, and there are four such operating systems with these specialized schedulers, then each has been designed so that it communicates with other schedulers in a manner that allows the sharing of resources of other schedulers. If each scheduler has attached to it certain resources that are known to other schedulers at the time of initialization (boot-up), then each scheduler at a given point in its operations can outsource to other schedulers operations that are not a part of its category of resources it provides.

Each Scheduler is assigned a portion of memory of which its shares with the other schedulers and when operations are being outsourced to other schedulers that require programs running with data sets to be accessed and manipulated in order to be completed, the outsourcing scheduler passes only the pointers and file descriptors to the receiving schedulers rather than the data volumes themselves. The pointers and file descriptors can be queued on the receiving scheduler for processing on its CPU.

### IPC Facilities and Protocol Stacks

Both IPC facilities as well as protocol stacks are spaced apart of the UNIX OS construct and are already well integrated as utilities. These utilities are also useful to the present invention. They can be configured to provide communication between operating systems in a cluster much in the form of which they were intended except now distributed computing is being incorporated with a particular computer system rather than across several platforms.

### IPC Scheduler

FIG. 8 illustrates a network controller as one resource, showing data packets 751 transmitted to a network operating system (NOS) 755. Referring to FIG. 8, the kernel scheduler provides a filter for the acquisition of resources processes, and the kernel scheduler first selects the resources required to determine where the processing should occur. Each CPU is a general purpose CPU, whereas each operating system's kernel becomes more specific and specialized to the allocation of a group or set of resources. FIG. 8 illustrates one embodiment of a specific and specialized operating system used in accordance with the present invention. The NOS 755 is capable of using any one or more of the protocols FTP, PPP, Modem, Airport, TCP/IP, NFS, and Appletalk, and using Port with the Proxy options.

It will be appreciated that memory is divided into quadrants, and portions of memory are divided between each operating system, whereas pointers and file descriptors can be passed from system-to-system through assignment rather than moving massive quantities of data. The IPC Facilities are used to allow processes to communicate messages in order to convey required transactions in the form of a Transactional Protocol.

In one embodiment, an application such as a speech synthesizer is able to run consistently on a CPU utilizing a particular I/O OS without interrupts to interrupt the processing. In another embodiment, an application such as a video stream is allowed to run utilizing a particular CPU, memory, and an OS without being controlled by a scheduler that swaps in and out programs during the course of its life.

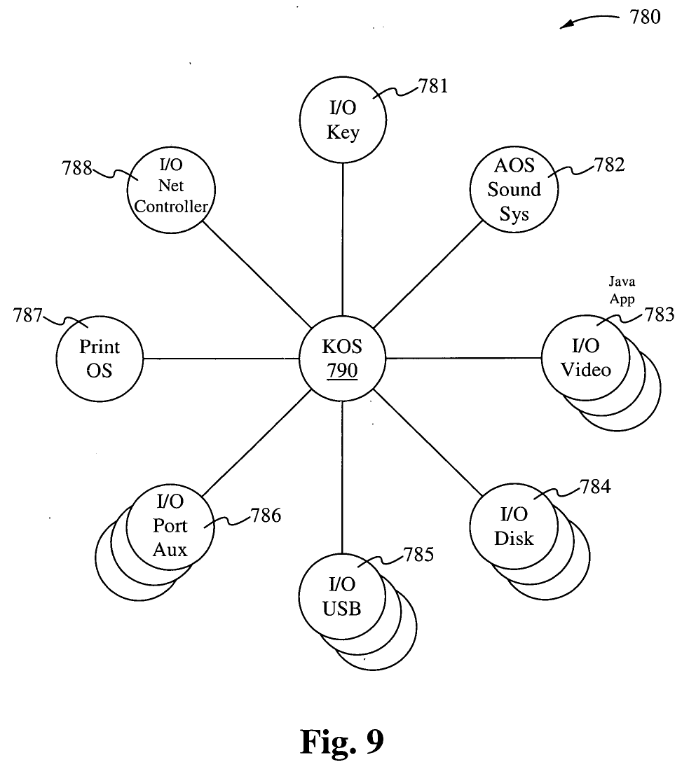

FIG. 9 shows a KOS 790 in accordance with one embodiment of the present invention, used to assign processes to an I/O key 781, an AOS sound system 782, an I/O video 783, an I/O disk 784, an I/O Universal Serial Bus 785, an I/O auxiliary Port 786, a Print OS 787, and an I/O Net controller 788. Referring to FIG. 9, an I/O bus has a controller, and the controller is the manager of resources on that bus. The resources are required to move data back and forth along the bus. Since I/O is a primary function of every computer it should no longer be a subfunction of an operating system. In accordance with embodiments of the present invention, an operating system coordinates multiple subordinate operating systems all operating in parallel as well as in asynchronicity.

### I/O Operating System

An I/O Operating system performs data retrieval from a centralized asynchronous central OS, and performs controller functions that determine how and when to transfer data.

In accordance with the present invention, a construct is deployed in which the functions of an Operating System based upon the concept of being portable can have its functionalities divided into threads, where a thread is similar to a process, but can share with other threads code, data, and other resources.

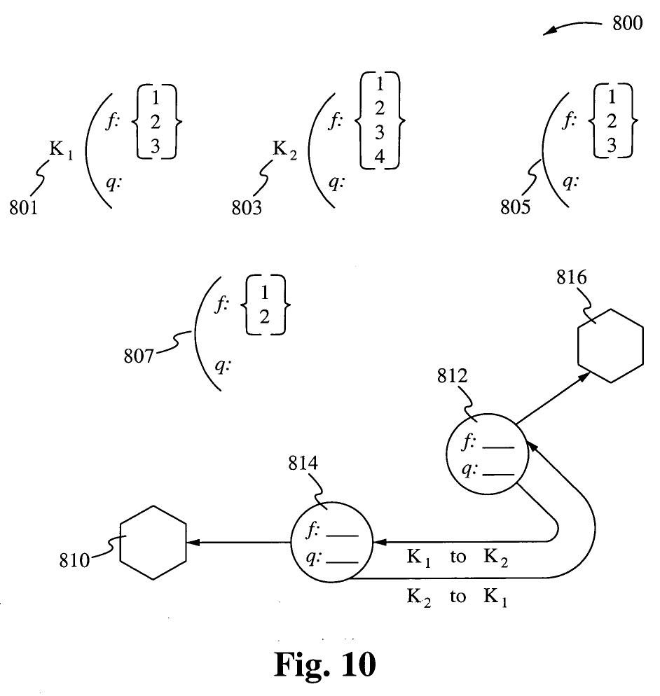

In one embodiment, illustrated in FIG. 10, a construct deploys the functions of an operating system 801, 803, 805, 807, 812, and 814, whereas the system calls all form asynchronous operating systems 810 and 816 operating together using threaded communication. Each operating system with its own separate kernel is specifically designed for two functions specialized and queue management. This arrangement breaks up cycle times by distributing all tasks around the computer and makes use of multiple CPUs. Each kernel is tied to a CPU, whereas controllers are replaced by CPUs or special purpose controllers.

### Primary KOS Process States

The following typical process states are possible on computer systems of all kinds. In most of these states, processes are “stored” on main memory.

### Created

(Also called “new.”) When an application is opened a process is first created, it occupies the “created” or “new” state. In this Application state, the process awaits admission to the “ready” RUN state. This admission will be approved or delayed by a long-term, or admission, KOS scheduler. During Admissions the process is checked for resources required before it is admitted into the run state otherwise it may be reassigned to the switch state to be switched to another CPU Operating Systems with the appropriate resources upon which it requires for running.

### Ready (WAIT)

This state is similar to the “Ready” primary process state discussed above.

### Running

This state is similar to the “Running” primary process state discussed above.

### SWITCHED (Formerly Blocked)

(Also formerly called “sleeping.”) Rather than having a process “block” on a resource (such as a file, a semaphore or a device), it will be removed from the current CPU and operating system (as a blocked process cannot continue execution) and will be in the blocked state, to another CPU and Operating System where the resource it requires is available continuously. Under the single CPU/single OS scenario, the process will remain “blocked” until its resource becomes available, which can unfortunately lead to deadlock. From the blocked state, the operating system may notify the process of the availability of the resource it is blocking on (the operating system itself may be alerted to the resource availability by an interrupt). Once the process arrives at the appropriate operating system where its resource is available, the process is admitted again to “ready” and can from there be dispatched to its “running” state, and from there the process may make use of its newly available resource.

### Terminated

This state is similar to the “Terminated” primary process state discussed above.

### Additional Process States

Two additional states are available for processes in systems that support virtual memory. In both of these states, processes are “stored” on secondary memory (typically a hard disk).

### Swapped Out and Waiting

This state is similar to the “Swapped and waiting” primary process state discussed above.

### Swapped Out and Blocked

This state is similar to the “Swapped out and blocked” primary process state discussed above.

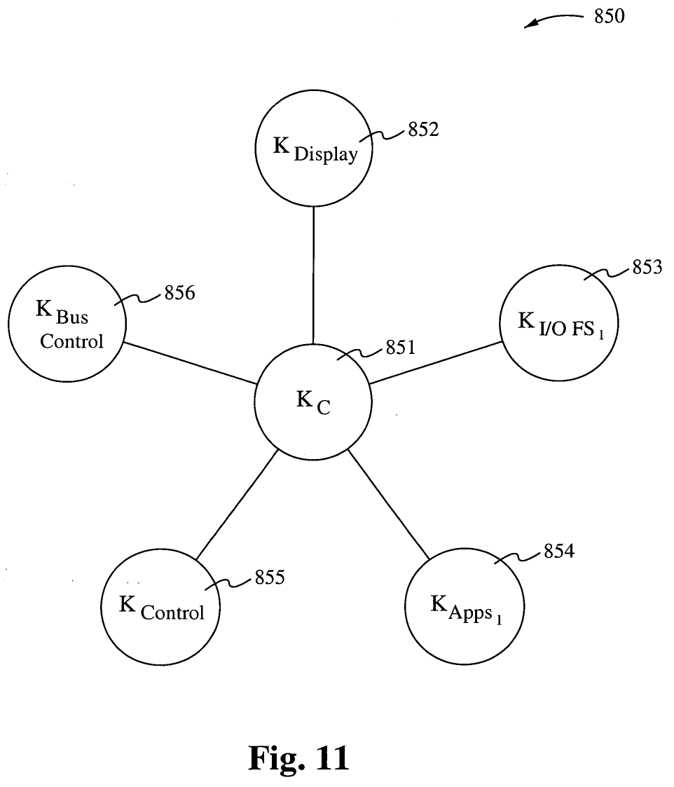

FIG. 11 illustrates signaling enabled protocols. For example, the protocol KC can be used to synchronize multiple kernels K_{DISPLAY} 852, K_{I/O File System 1} 853, K_{APPS 1} 854, K_{CONTROL} 855, and K_{BUS CONTROL} 856. A method for synchronizing three or more kernels to work asynchronously with a central and core kernel in an operating environment is discussed. A UNIX operating system normally consists of a core known as the kernel, whereas the kernel performs all of the central commands and distributes a plurality of processing or nodes across the environment that performs certain tasks that carry out the operations. The method being described herein differs by allowing first the central core kernel to outsource the bulk of all input and output operations to an I/O kernel, which will then carry out the remainder of such operations without further burden on the central kernel or the core.

Inside an operating system, file I/O, the transfer of data to and from memory, occupies a large percentage of the operations of the conventional kernel and when a conventional kernel can be freed from such burdensome tasks, i.e., I/O operations performed by the kernel such as the management of applications and interpreting commands and other core arrangement such as scheduling processing time on a particular CPU will complete with decreased latency.

The method describes a task separation between the operations of a central hierarchical kernel and several subordinate and/or asynchronous kernels. A symmetric kernel processing environment where symmetric kernels asynchronously process shared information using environmental variables to control and dictate collisions that may otherwise occur under such environmental conformities. The method also describes multiple rotating kernels on a symmetric metaphysical wheel-like apparatus, all sharing information through environmental variables which are used to control collisions between kernels and the commands and data they operate on.

### Communication Protocols

In accordance with embodiments of the present invention, communication protocols are defined as communication between kernels running under the environments, and communication protocols between processes running under those kernels. The Communication protocols allow three or more processes to exist and communicate between each simultaneously by having the communication managed by a process, which is external to the particular type of communication being addressed. Depending on the type of configuration architecture, the Communication Protocols may be designed differently.

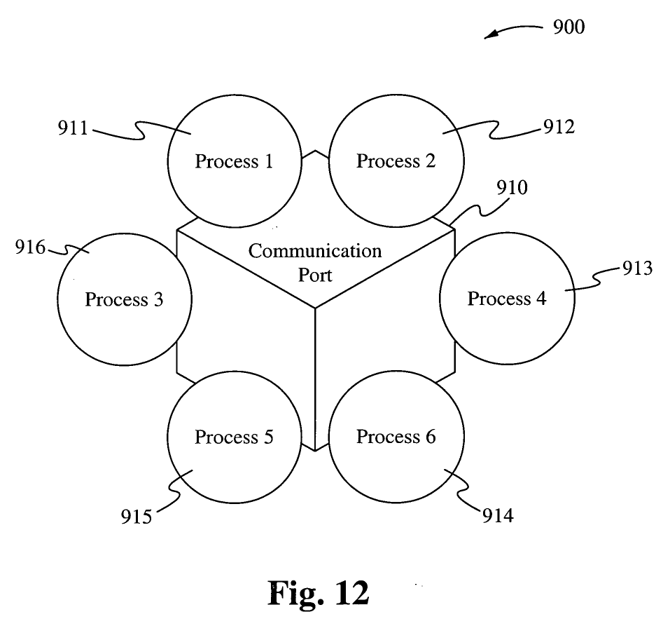

Processes line up to communication ports instead of a table for communication between processes. As shown in FIG. 12, processes 911-916 are all trying to access a communications port 910. A Processes Manager manages the communication between processes as requests and resources are released. During this port-like communication process, one of the many advantages offered above those under a standard IPC table configuration is that more than two processes may communicate simultaneously. Another advantage is that all communication is managed by a protocol between processes rather than a handshake abstract. When six or more processes line up to establish communication between each other, each process must establish a direct line between itself and one or more others.

For example, in FIG. 12, process 911 has resource A to release, and process 912 comes to request resource A. Communication is established between processes 911 and 912 by which they have a shared relationship with resource A, one which is managed by the Process Manager which conducts communication between the two processes. If the process 911 and the process 912 both request resource C under the given scenario, and the process 911 is releasing resource A while requesting resource C, yet process 915 has not arrived to release resource C, then request of the process 912 is blocked until the process 911 retrieves resource C and releases it. The given scenario is governed by the fact that there are more processes requesting resources and there may be less than adequate resources available.

The managers discussed below, including but not limited to the Relationship Manager, the Processor Manager, the Thread Manager, the Resource Manager, and the Resource Allocation Manager, are all used in accordance with embodiments of a KOS in accordance with the present invention. The discussions below describe how these managers, and other components of a KOS, function.

### Relationship Managers

The Relationship Manager manages the relationships between the numbers of kernels operating in the environment at any given time. Although each kernel may be responsible for any number of given threads executing their kernel code, this factor does not enter into the tasks performed by the Relationship Manager. The tasks performed by the Relationship Manager in accordance with embodiments of the present invention are those that involve the kernels and their relationship to each other.

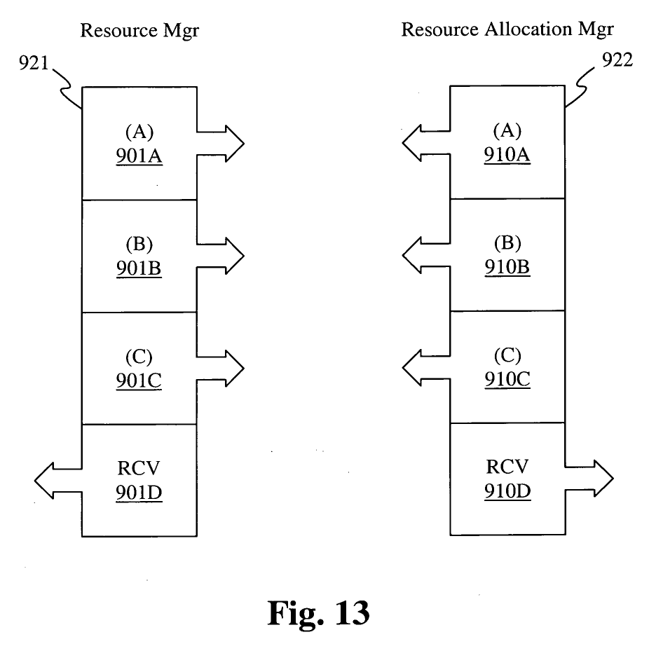

Each Relationship Manager, depending on the type of configuration, communicates using certain established protocols to share information between Kernels organized within a Ring-Onion Kernel System, or across Operating Systems within each of the four configuration architectures. This is illustrated in FIG. 13, which shows a Resource manager 921 and a Resource Allocation manager 922. Within FIG. 13, called out as Resource Sharing, the protocol {A1} represents protocol data being sent out from the Relationship Manager requesting knowledge of certain resources that reside within the environment. {B1} in the present diagram and under the same Resource Manager, represents another layer of the very same protocol which announces information about freed up resources or estimated time until resources are released. {C1}, a third parameter and protocol layer indicates information being received about resources that have been requested, freed or where certain resources reside.

In another example, the Relationship Manager, RM1 makes a request for resource A1 under a Relationship Manager RM2. If Relationship Manager RM2 is aware of A1 being in use, Relationship Manager RM2 might perhaps estimate a length of time for release of A1 by making that request of its Resource Manager RsMgr2, thus sending information back to the origin of the request through a system of layered protocols.

Once RM1 becomes aware of A1's release, RM1 signals RM3 using, for example, a specific protocol layer. As soon as RM3 becomes aware that its kernel or one of its kernel's threads has occupied the A1 resource, RM3 signals the Resource Allocation Manager of all operating kernels or operating systems in the environment if under a ring architecture, and only the command control operating system or kernel if under a Star-Center architecture.

### Configurations For Task Distribution

Although the schedulers resident to all kernels are central to how tasks are distributed throughout any execution, these schedulers are also central to the present invention and how the flow of work is carried out. There are four or more types of configurations under which embodiments of the present invention carry out tasks assigned to the environment and they are determined to be the central command structures for the environment and are as named below:

### Architectures

### 1. Hierarchical Structure

In a hierarchical structure where multiple kernels are running simultaneously in an environment under the present invention, the host kernel is central to all control and receives all incoming jobs or tasks that are to be executed by the environment. The Command kernel screens the task for resources required and assigns the particular task to the appropriate kernel where the said task is to be carried out until completion. Under the Command kernel is a Relationship Manager, which manages the relationship between the Command kernel and the subsequent kernels running in the environment. The Relationship Manager manages the other kernels through a control protocol structure similar to the one described above. The Relationship Manager records and balances the resource requests and resource requirements between each of the other kernels running inside the environment. To perform this chore, the Relationship Manager must understand where all tasks and jobs were originally assigned and why they were assigned to a particular kernel. Under the hierarchical structure, resources installed in the environment are assigned to a particular kernel; for example, printers are assigned to a particular kernel whereas video screens are assigned to another kernel. Tasks requiring a particular I/O driven task will not interrupt a video/audio driven task due to delay in obtaining a particular resource.

### 2. Round-Robin

A Round-Robin configuration consists of tasks being assigned to kernels in a pre-determined order. In this case, if the kernel does not contain the resource required to perform the task, the Relationship Manager is responsible for forwarding that task to the next kernel in order. In accordance with the present invention, a Round-Robin configuration may be suitable for many different platitudes of situations, however in others it might not yield the desired benefits intended by the present invention.

Under a Round-Robin configuration, each kernel runs in the environment asynchronously against other kernels, and are linked by the Relationship Managers which are thus in communication with each Resource Manager under each respective kernel. Round-Robin configurations do not have a central point of control. In this configuration, there are no command kernels. Each kernel is considered to be in an abstract circular configuration and connect to the other kernel through their respective Relationship Managers.

### 3. First-in First-Out

Under a FiFo configuration each kernel executes each task presented to the environment under a first-come-first-served basis. Should a particular task be present to a kernel, and the kernel is freed up enough to accept the given task, it is the kernel where the task will reside until the task becomes blocked for a resource.

### 4. Star-Center

The Star-Center architecture is defined by having a circle of multiple kernels surrounding a central command kernel. The central command kernel is the controlling kernel whereby it uses its facilities to receive and organize task requests for other kernels under the Star configuration. The Star-Center configuration groups subordinate kernels in a constellation according to the resources within the environment. Consider operating systems where a given task is requiring the use of a given resource while others are often blocked on that resource until the one completes it use. In accordance with the present invention, the kernel threads are dedicated to running copies of a particular kernel in overcoming such a bottleneck while allowing other kernels to use their threads accordingly. One of the many conditions for multiple operating systems is to allow specialized kernels to handle specific resources using the ability to thread out copies of their code to handle multiple attached resources of a certain type; thus running not only on multiple CPUs, but multiple kernels running multiple copies of themselves across a multiplicity of CPUs.

### 5. Ring-Onion Kernel System

In a Ring-Onion Kernel System, multiple strip-down kernels work simultaneously inside an operating system's service structure. The operating system's service structure refers to all ancillary and auxiliary files that make up a particular operating system set of services. These services may be shared. Under this architecture, such as system call facilities and other mechanisms external to kernel code, given the multiplicity of the design, performance under certain requirements may be impacted. In the case that the Ring-Onion Kernel System, the kernels all perform tasks of single operating system kernels, but perform them asynchronously with respect to one another, and perform them on separate CPUs while sharing the ancillary files and facilities.

FIG. 1, above, illustrates a Ring-Onion Kernel System where a system of kernels performs tasks asynchronously yet share the same services and facilities. While each kernel has a set of immediate service facilities within its local space, the broader services are shared between all kernels within the environment.

While FIG. 1 shows all kernels operating asynchronously to each other without a command and control kernel, architectures in accordance with the present invention also allow for the installation of a command and control kernel, whereby a similar specification of the Star-Center system architecture would apply in concert with the Ring-Onion architecture.

### Multi Processor Synchronization

One of the basic assumptions in traditional synchronization models held is that a thread retains exclusive rights and use of the kernel (except for interrupts) until it is ready to leave the kernel or blocks on a resource. This is no longer a valid model regarding multiprocessors, since each processor could be executing kernel code at the same time. Under a multiprocessor model using multiple threads, protection is required for all types of data when each processor is capable of executing its copy of the kernel code. Under the present invention, these types of protections are valid because there are multiple kernels inside an environment, and each kernel has multiple threads as a result of operating with multiple processes all running their own copy of kernel code.

### Processor Managers

A processor, hence CPU, becomes a resource to be managed as are other resources under the present invention. More specifically, a Processor Manager is a process that manages the number of CPUs and their allocations to kernels running under the environment, or copies of the kernel-specific process that manages the use of kernel threads. Each request for use of a kernel thread that will execute a copy of a specific kernel code to utilize a particular resource is subjected to management under the processor manager. The number of processors must be catalogued and allocated by the processor manager to each thread that is executing inside the present environment.

One example provides access to an interprocess communication table where processes communicate, especially one that exists in modern kernels. This data structure is not accessed by interrupt handlers, and does not support any operations that might block the processes that access it. Hence, on a uniprocessor system, the kernel can manipulate the table without locking it. However, under a multiprocessor system, this cannot be the case. Therefore, under the present invention, such a table must be expanded upon creating cooperation between processes running multiple copies of their resident kernel code, and multiple kernels requiring use of multiple resources attached to other kernels. In accordance with the present invention, such a table must be locked once two processes access it to communicate between processes simultaneously, and it is suggested that modifications be made to the present abstract to allow the management of such a table to be performed by the Processor Manager. When two or more processes attempt to access the IPC table simultaneously, the Processor Manager must implement the locking of the table until one or more processes have terminated their communication link and before another process can be allowed to access the table. Although the locking mechanism is a primitive in IPC communications, under the present invention it can be expanded upon above that of multiprocessor system IPC in order to allow three or more processes to communicate at any one time.

### Inter-process Communication Table

### Inter-Kernel Communication Table

Under a traditional kernel system, the kernel simply checks the locked flags and sets them to the lock position in order to lock the table, or resets them upon unlocking the table. Under the present invention, the IPC and IKT become another resource in the system to be managed accordingly. The complexity of the table creates the level of sophistication of the system environment. As under the present invention as also on a multiprocessor system, two threads running on different processors but managed by a Processor Manager can concurrently examine a single locked flag for the same resource. If both will find it clear, both will attempt to access the particular resource simultaneously. Therefore in accordance with the present invention, only one process performs the examination of flags, and in this case such examinations are performed by the Processor Manager if the resource is a processor, and the Resource Manager if the resource is something other than a processor. The present installment of a manager is a measure of prevention in the event that simultaneous access may result in unpredictable results.

### Thread Managers

In accordance with the present invention, a Thread Manager is defined as a process that runs under the present local kernel that keeps track of all uses of threads assigned to lightweight processes (LWPs) and other processes running under that kernel. The Thread Manager reports this information to other management systems running to assist in the synchronization of the Multiple Kernel Environment. If the MKE is organized in one of the five configurations above, the Thread Manager's reporting may be altered to meet the requirements of the particular environment. It is important for the Thread Manager, for instance, to report the number of threads assigned in order to better track the given resources under a particular system. The reporting of resources falls under the responsibilities of the Resource Manager; therefore the Resource Manager hereby relies on the Thread Manager to provide this type of information.

### Resource Manager

In accordance with the present invention, the Resource Manager is defined as a manager of resources that are considered to exist within the environment. Resources, for example are considered to be vital components to any operating system environment, and thus under a system where there are or may be multiple kernels residing, the statement bears no lesser meaning. A Resource Manager manages the resources residing at the local kernel level, and whenever a certain task requires a particular resource, their requests are via the Resource Manager, and should the request be for a resource not available on a particular kernel, the Resource Manager contacts the Relationship Manager in effort to build a relationship between the task requiring the resource and the kernel which has the particular resource.

### Resource Allocation Manager

In accordance with the present invention, the Resource Allocation Manager performs the recording of all resources that have been allocated between processes that have started tasks that have originated on one kernel using a particular resource but require the resources that may be attached to another kernel. Under such circumstances, the Resource Manager may need to contact the Resource Allocation Manager in efforts to find a certain resource, or to inventory all of the available resources within the environment. In such cases, the Resource Allocation Manager which manages all resource allocations between kernels provides the necessary information to the Resource Manager.

Under certain architectures, the Resource Allocation Manager, and the Resource Manager may exist in OSs or Kernel Systems other than the Command Kernel System or Operating System within the Environment. For the sake of discussion about embodiments of the present invention, the Resource Allocation and Resource Manager both exist as a part of the Command Operating and Kernel System.

### Additional Examples

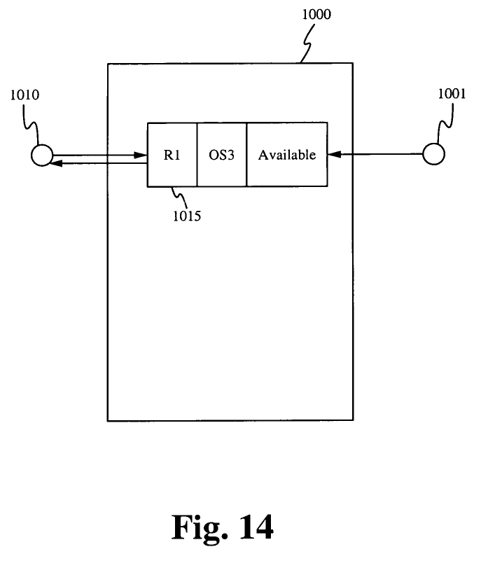

FIGS. 14-23 show more detailed examples of embodiments of the present invention. In accordance with one embodiment of the present invention, KOSs execute within individual operating systems, not centrally. Processes exchange information, such as using shared memory, to notify other processes when a resource is available or when a resource may become available. As one example, FIG. 14 shows two processes 1001 and 1010 exchanging information about a resource R1 using shared memory 1015. The shared memory 1015 contains information indicating that the resource R1, for which the process 101 was waiting, is now available. The process 1010 may now request the resource, such as by making a call to the resource.

It will be appreciated that while FIG. 14 shows shared memory containing information about a single resource, in other embodiments shared memory contains information about many resources. The shared memory is also able to contain information different from or in addition to that shown in FIG. 14.

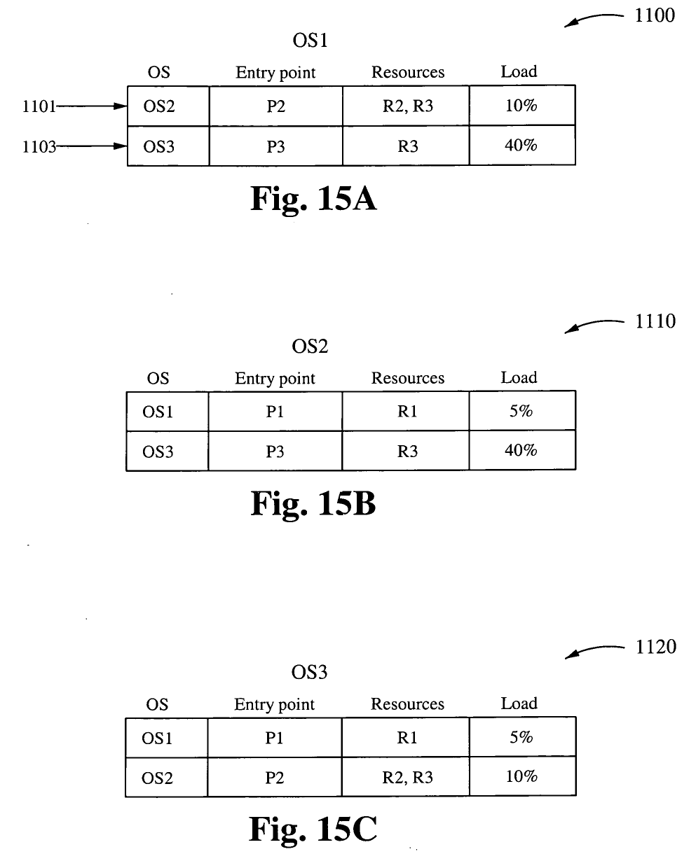

In another embodiment, each KOS contains a table indicating the other KOSs and the resources each supports. The table also indicates how the resource is invoked (such as by an entry point or system call to the operating system), and the load on the processor that is currently executing the particular operating system. For example, in a three processor environment, each processor executing a KOS and supporting different resources, FIGS. 15A-C show the tables stored in each KOS. FIG. 15A, illustrating a table stored in an operating system OS1. Row 1101 in FIG. 15A shows that the operating system OS2 has an entry point P2, supports resources R2 and R3, and has a system (processor) load of 10%. Row 1102 shows that the operating system OS3 has an entry point P3, supports the resource R3, and has a load of 10%.

The table in FIG. 15B for OS2 and the table 15C for OS3 are similarly explained and will not be described here. In operations, the operating systems periodically exchange information, such as at specific times or when its resource parameters change over a predetermined threshold.

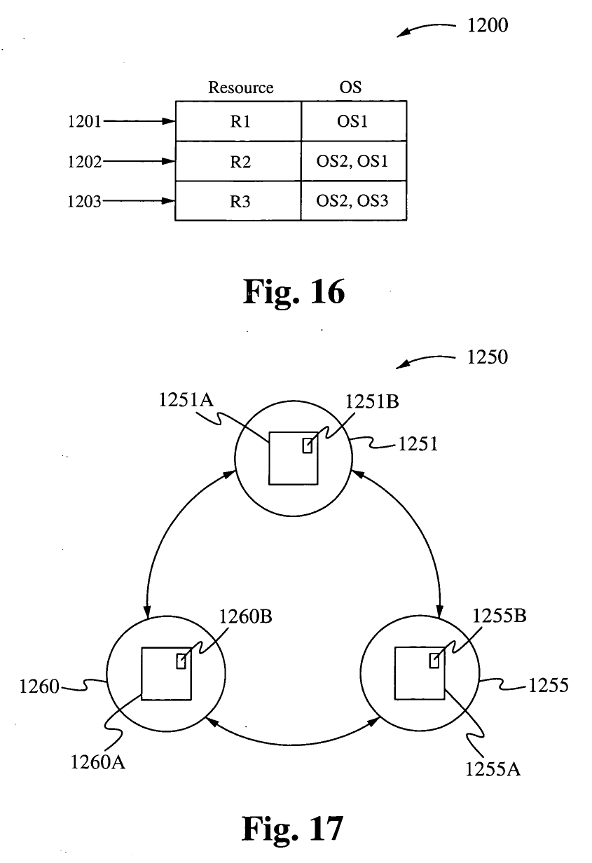

FIG. 16 shows a table storing resource information in a different format, mapping resources to operating systems. For example, row 1202 in the table of FIG. 16 shows that the resource R1 is currently accessible through OS1, row 1202 shows that the resource R2 is accessible through OS2 and OS1, and row 1203 shows that the resource R3 is accessible through OS2 and OS3.

The tables in FIGS. 15A-C and 16 are merely exemplary. Those skilled in the art will recognize many different formats and types of information to include in resource tables in accordance with embodiments of the present invention.

FIG. 17 shows a system 1250 with multiple KOSs exchanging resource information in accordance with one embodiment of the present invention. The system 1250 includes a KOS 1251 having a relationship manager 1251A and a resource manager 1251B, a KOS 1255 having a relationship manager 1255A and a resource manager 1255B, KOS 1260 having a relationship manager 1261A and a resource manager 1260B. As explained above, when a KOS needs a resource, it checks its local kernel level using the resource manager. If the resource cannot be found or is unavailable, it invokes its relationship manager to access the resource though another kernel operating system.

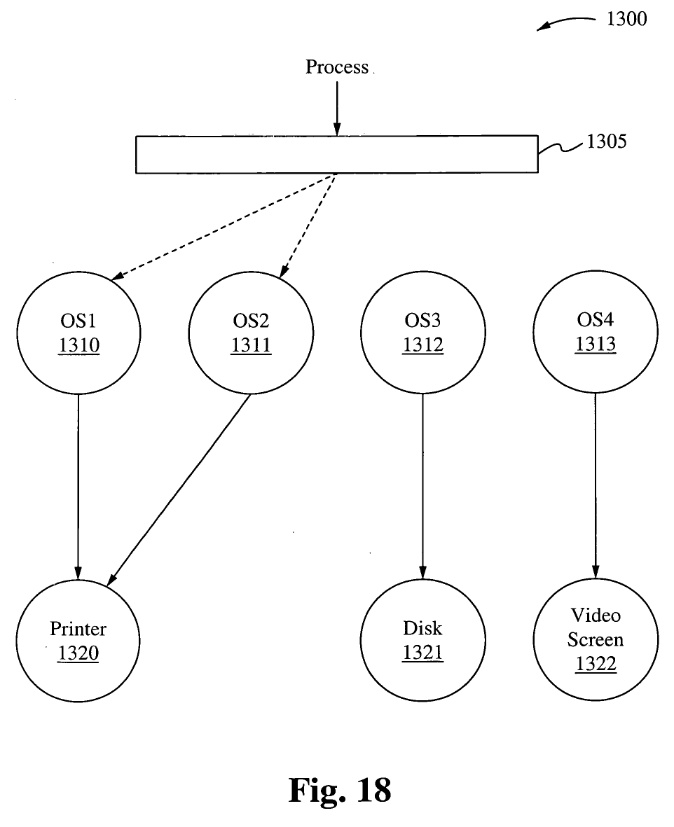

FIGS. 18-23 illustrate embodiments of a central KOS in accordance with the present invention. FIG. 18 shows a computer system 1300 executing multiple operating systems OS1 1310, OS2 1311, OS3 1312, and OS4 1313, each configured to access one or more resources. The operating systems OS1 1310 and OS2 1311 are both configured to access a printer 1320. The operating system OS3 1312 is configured to access a disk 1321, and the operating system OS4 1313 is configured to access a video display 1322. In one embodiment, OS 1313 is specifically adapted to interface with a video display. For example, the OS1313t, may include a video display driver, while OS 1310, OS2 1311, and OS3 1312, do not; or its interface to the video display 1322 supports more features, has a smaller footprint, is faster, or any combination of these. Those skilled in the art will recognize many reasons why only some operating systems on the system 1300 are configured to access resources but others are not or why some operating systems are better suited than others to access certain resources.

In operation, the process requests the use of a resource and is introduced to the kernel operational scheduler (KOS) 1305. The KOS 1305 first determines which of the kernel operating systems 1310-1313 is best able to supply the requested resource to the process and then assigns the process to the selected kernel operating system. When multiple kernel operating systems are able to supply the requested resource, the KOS 1305 uses selection criteria as discussed below. As one example, the process calls a print function to access the printer 1320. Though both OS1 1310 and OS2 1311 are able to access the printer 1320, OS 1310 is selected because it is less busy.

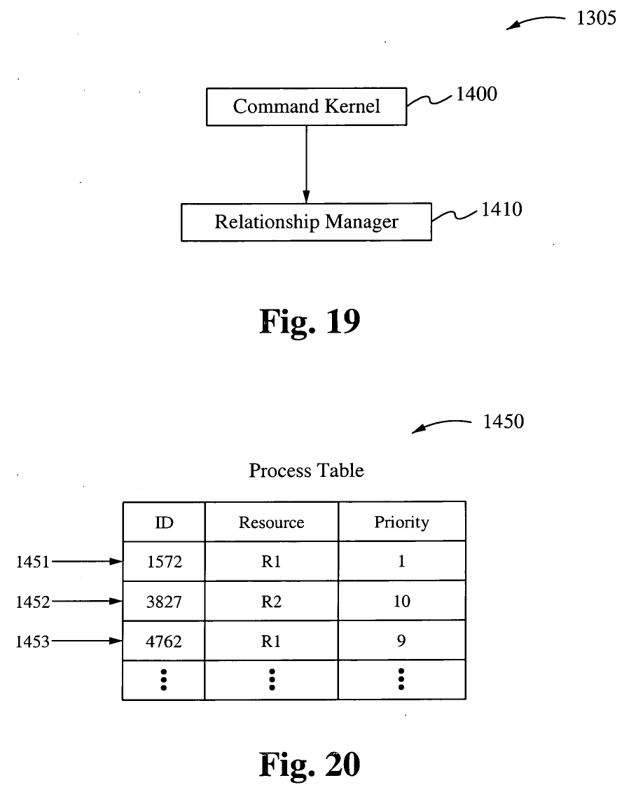

FIG. 19 shows the KOS 1305 in more detail. As shown in FIG. 19, in one embodiment, the KOS 1305 includes a Command Kernel 1400 and a Relationship Manager 1410.

FIG. 20 shows a process table 1450 stored in the Relationship Manager 1410 of FIG. 19 in accordance with one embodiment of the present invention. The process table stores information about processes, the resource they are assigned to, and their priorities. For example, row 1451 of the table 1450 shows that the process with the process ID 1572 is currently assigned to the resource R1 and has a priority of 1.

It will be appreciated that other information can be stored in the process table 1450, such as information indicating whether a process is waiting on a resource, how long it has been waiting for a resource, to name only a few other types of information.

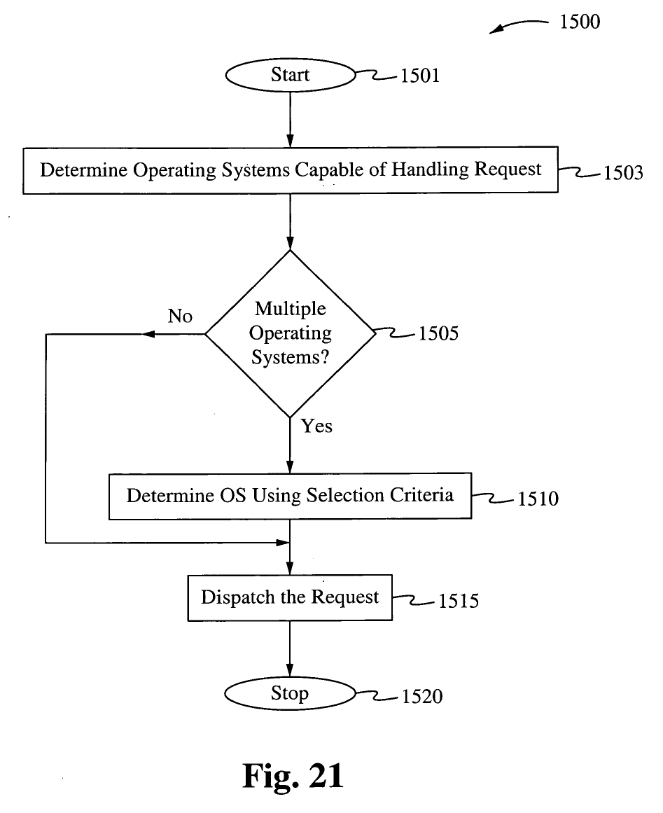

FIG. 21 is a flow chart of a method 1500 of scheduling a kernel operating system to handle a process in accordance with one embodiment of the present invention. After the start step 1501, in the step 1503 the method determines whether any of the operating systems (OSs) executing on the computer system are capable of providing the resource. Next, in the step 1505, the method determines whether more than one of the OSs are capable of providing the resource. If only one of the OSs is capable of providing the resource, the method skips to step 1515; otherwise, it enters step 1510.

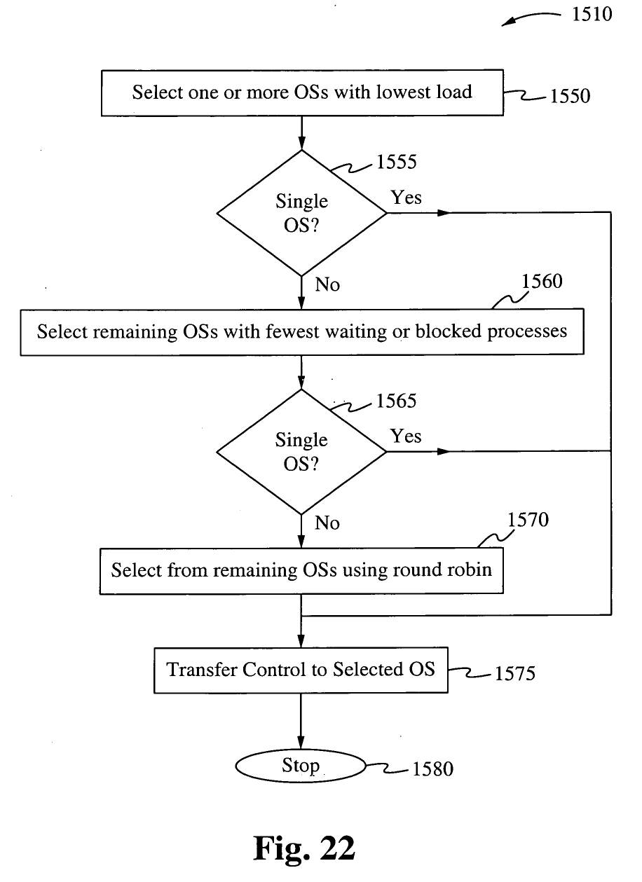

In the step 1510, one of the multiple OSs is selected using one or more selection criteria, as discussed below in relation to FIG. 22, the method enters step 1515. In the step 1515, the resource is allocated to the process, and in the step 1520, the method ends.

FIG. 22 shows the step of the method 1510, shown in FIG. 21, for selecting a kernel operating system from among multiple kernel operating systems that can all supply a requested resource. In the first step 1550, the method selects the operating system with the smallest load. In the step 1555, the method determines whether a single OS satisfies this criteria. If so, the method skips to the step 1575. Otherwise, the method continues to the step 1560, eliminating from consideration only those OSs with the smallest load.

In the step 1560, the method selects, from the remaining OSs, those that have the fewest waiting or blocked processes, eliminating the rest from consideration. In the step 1565, the method determines whether only a single OS had the fewest remaining or blocked processes. If only a single OS had the fewest remaining or blocked processes, the method skips to the step 1575. Otherwise, the method continues to the step 1570, where a single OS from among the remaining OSs is selected in a rotating or other round-robin fashion. Next, in the step 1575, the process is allocated the requested resources through the selected OS. The method stops in the step 1580. Here, the “selection criteria” are said to include the status of OSs (a number of blocked or waiting processes and loads on processors executing OSs).

It will be appreciated that the steps 1510 are merely exemplary. Those skilled in the art will recognize many variations. For example, the steps 1510 are able to be arranged in different orders; some of the steps are able to be added and others deleted; or an entirely different set of steps is performed. As one different step, when two OSs are both able to supply a resource, the OS executing on the faster microprocessor is selected.

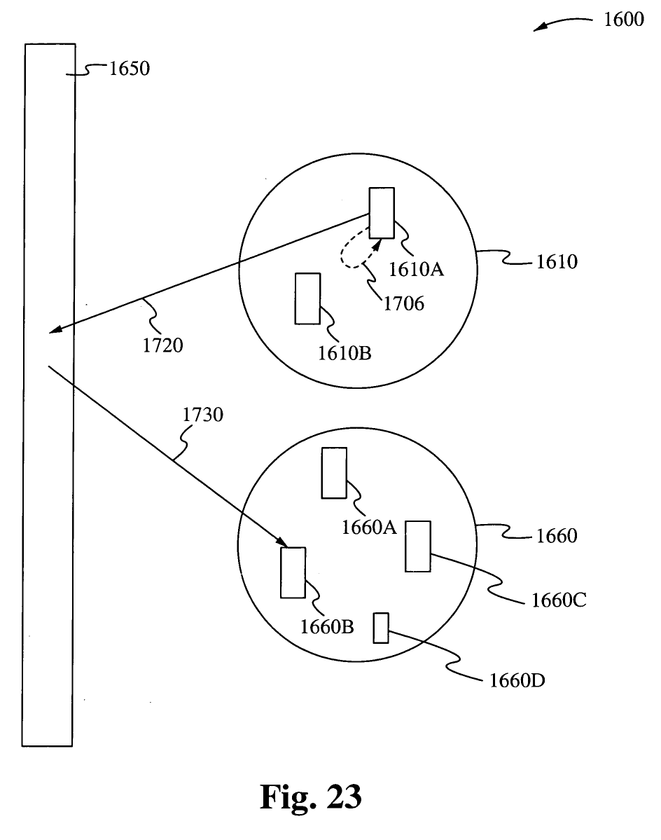

FIG. 23 shows components of a system 1600 and a sequence of transactions when a process requests a resource on a computer system in accordance with one embodiment of the present invention. The system 1600 includes an operating system 1610 executing a process 1610A and providing access to a resource 1610B, an operating system 1660 executing a process 1660A and providing access to resources 1660A-D, and a KOS 1650.

As shown in FIG. 23, the process 1610A makes a request 1706, such as through a resource manager, for the resource 1660B. As shown by the dashed line 1706, the resource was not available locally, so a request 1720 for resource 1660B is forwarded to the KOS 1650. The KOS 1650 determines that the OS 1660 can provide the resource, so a request 1730 for the resource is forwarded to the OS 1660, which provides the resource 1660B.

The step of “providing” a resource depends on the particular resource requested. If the resource is a CPU, assigning can include placing an identifier for the process in a run queue in the OS 450. If the resource is a disk, assigning can include putting the process on a queue that will dispatch the process to the disk.

In accordance with the present invention, processes are able to be handed-off from one OS to another. As one example, when a process is accessing a resource through one OS, the processor executing that OS may be assigned other tasks and thus may slow down. In other words, the OS is the resource. A KOS in accordance with the present invention is able to reassign the process to another CPU that is able to execute the process more efficiently.

Embodiments of the present invention allow resources to be shared more efficiently, balancing the load among operating systems that provide the resources. This reduces bottlenecks, process starvation, and other symptoms that plague multi-processor systems. Moreover, processes can be easily assigned to resources and operating systems that are specialized to perform specific tasks, also leading to more efficient process execution.

It will be appreciated that a KOS in accordance with the present invention, each of its components, and each of the algorithms discussed herein, are able to be stored on computer-readable media, containing computer executable instructions for realizing the functionality of a KOS. The instructions are able to be stored on the computer-readable media as one or more software components, one or more hardware components, combinations of these, or any element used by a computer to perform the steps of an algorithm.

While the present invention has been described in terms of specific embodiments incorporating details to facilitate the understanding of the principles of construction and operation of the invention, such references herein to specific embodiments and details thereof are not intended to limit the scope of the claims appended hereto. It will be apparent to those skilled in the art that modifications may be made in the embodiments chosen for illustration without departing from the spirit and scope of the invention as defined by the appended claims.

I claim:

1. A computer system comprising:
multiple resources; and
a memory containing multiple operating systems each containing a kernel scheduler, wherein the multiple kernel schedulers are configured to coordinate allocating the resources to processes executing on the computer system.

2. The computer system of claim 1, further comprising multiple central processing units each executing on a different one of the multiple central processing units.

3. The computer system of claim 1, wherein the multiple resources comprise any two or more of a keyboard controller, a video controller, an audio controller, a network controller, a disk controller, a universal serial bus controller, and a printer.

4. The computer system of claim 1, wherein the multiple kernel schedulers are configured to share resource-related information using a communications protocol.

5. The computer system of claim 4, wherein the communications protocol is configured to access a shared memory.

6. The computer system of claim 4, wherein the communications protocol comprises interprocess communication or protocol stacks.

7. The computer system of claim 4, wherein the communications protocol comprises Transmission Control Protocol/Internet Protocol.

8. The computer system of claim 4, wherein the communications protocol comprises accessing semaphores, pipes, signals, message queues, pointers to data, and file descriptors.

9. The computer system of claim 4, wherein the processes comprise at least three processes communicating with each other.

10. The computer system of claim 1, wherein each of the multiple kernel schedulers comprises a relationship manager for coordinating allocating the resources.

11. The computer system of claim 10, wherein each of the multiple relationship managers comprises a resource manager configured to determine resource information about one or more of the multiple resources.

12. The computer system of claim 11, wherein the resource information comprises an estimated time until a resource becomes available.

13. A computer system comprising:
a memory containing a kernel scheduler and multiple operating system kernels configured to access multiple resources, wherein the kernel scheduler is configured to assign a process requesting a resource from the multiple resources to a corresponding one of the multiple operating system kernels.

14. The computer system of claim 13, further comprising multiple processors each executing a corresponding one of the multiple operating systems.

15. The computer system of claim 14, wherein the kernel scheduler schedules processes on the multiple operating system kernels based on loads on the multiple processors.

16. The computer system of claim 13, wherein the resources comprise any two or more of a keyboard controller, a video controller, an audio controller, a network controller, a disk controller, a universal serial bus controller, and a printer.

17. The computer system of claim 13, further comprising a process table that matches a request for a resource with one or more of the multiple operating system kernels.

18. The computer system of claim 13, further comprising communications channels between pairs of the multiple operating system kernels.

19. The computer system of claim 13, wherein the multiple operating system kernels are configured to exchange information about processor load, resource availability, and estimated times for resources to become available.

20. A kernel scheduling system comprising:
multiple processors, each executing an operating system kernel and configured to access one or more resources; and
an assignment module programmed to match a process requesting a resource and to dispatch the process to one of the multiple operating system kernels capable of accessing the resource.

21. The kernel scheduling system of claim 20, wherein each of the multiple processors is controlled by a corresponding processor scheduler.

22. A method of assigning a resource to an operating system kernel comprising:
selecting an operating system kernel from among multiple operating system kernels based on its ability to access the resource; and
assigning the process to the selected operating system kernel.

23. The method of claim 22, wherein the multiple operating system kernels all execute within a single memory.

24. A method of sharing process execution among first and second operating systems on a memory of a single computer system comprising:
executing a process within the memory under control of the first operating system; and
transferring control of first process to a second operating system within the memory, thereby executing first process within the memory under the control of the second operating system.

25. The method of claim 24, wherein executing the process under control of the first and second operating systems both access a single resource.

26. The method of claim 25, further comprising exchanging process information between the first and second operating systems using one of shared memory, inter-process communication, and semaphores.
